(19) United States
(12) Patent Application Publication
(10) Pub. No.: US 2025/0278391 A1
(43) Pub. Date: Sep. 4, 2025

(54) CONTROLLING QUALITY OF DYNAMICALLY IDENTIFIED METADATA TRANSFERRED AMONG ENVIRONMENTS

(71) Applicant: Ab Initio Technology LLC, Lexington, MA (US)

(72) Inventors: Robert Parks, Weston, MA (US); Larry Paul Rossi, Colorado Springs, CO (US); Halldor Gylfason, Lexington, MA (US); Nathaniel Brooks, Lexington, MA (US); Ted Bach, Lexington, MA (US); Tyler Millis, Cranston, RI (US)

(21) Appl. No.: 18/662,539

(22) Filed: May 13, 2024

Related U.S. Application Data
(60) Provisional application No. 63/559,579, filed on Feb. 29, 2024.

(51) Int. Cl. G06F 16/215; G06F 11/36; G06F 16/21

(52) U.S. Cl. CPC G06F 16/215; G06F 11/3698; G06F 16/219

(57) ABSTRACT

A method for delivering a dynamically identified set of related metadata of a specified quality to a target environment for metadata-driven processing of data includes, in a source environment, dynamically identifying a related set of metadata including given metadata and metadata related to the given metadata, processing identified metadata corresponding to the related set of metadata with one or more quality rules to determine whether the identified metadata has a specified quality, and in accordance with the identified metadata having the specified quality, making the identified metadata available for metadata-driven processing of data in the target environment.

### CROSS-REFERENCE TO RELATED APPLICATIONS

This application claims priority under 35 U.S.C. § 119 (e) to U.S. Patent Application No. 63/559,579, filed on Feb. 29, 2024, the entire contents of which are hereby incorporated by reference.

### TECHNICAL FIELD

This disclosure relates to techniques for controlling the quality of dynamically identified metadata that is transferred among computing environments.

### BACKGROUND

Modern data processing systems manage vast amounts of data within an enterprise. A large enterprise, for example, may have millions of datasets. These datasets can support multiple aspects of the operation of the enterprise. Complex data processing systems typically process data in multiple stages, with the results produced by one stage being fed into the next stage. The overall flow of information through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

During a typical application development lifecycle, developers work collaboratively on different application components. Some of these application components may depend on others. For example, a front-end developer may work on a front-end component of an application, which interfaces with a back-end component of the application developed by a back-end developer, which in turn relies on data from a database component of the application developed by a database developer. When development of the various application components is finished, they are moved as a whole from a development stage to a test or integration stage for testing before entering a production stage. FIG. 1A illustrates an example of software development as described in U.S. Pat. No. 11,294,655, titled “Computer-automated software release and deployment architecture.” FIG. 1B is an annotated version of FIG. 1A.

### SUMMARY

The present disclosure relates to techniques for controlling the quality of dynamically identified metadata and related data that is transferred from a source environment to a target environment.

In general, an executable application, such as a dataflow graph or another executable computer program, can be developed according to an application lifecycle that takes place across multiple environments. Each environment consists of hardware and software resources configured to serve a unique purpose within the application development lifecycle. For example, an application may be created in an authoring environment, tested and validated in an integration environment, and deployed in a production environment. This staged approach ensures reliability and repeatability during application development, and reduces risk in the event that problems with the application arise.

In some examples, an environment can include its own set of metadata and technical data, and an application can be configured to execute in accordance with the metadata and technical data in the environment. For example, consider a dataflow graph that reads data from a source dataset, transforms the data, and writes the transformed data to a target dataset. In this example, metadata entities can specify attributes of the source and target datasets (e.g., fields names, record formats, access information) that enable the dataflow graph to read from and write to the datasets. In addition, technical data can specify the logic for transforming the data. Without the metadata, the application may not be able to access the datasets; without the technical data, the application may not be able to transform the data.

The metadata within an environment can also control the generation of an application, such as by controlling the selection and/or implementation of rules, controls, and other logic within the application. For instance, in the foregoing example, an entity representing a field of the source dataset may be marked as personally identifiable information (PII) (or the entity representing the field may be linked to another entity that is marked as PII). This metadata can cause a data processing system to automatically insert masking logic, or other data obfuscation logic, into the dataflow graph in order to mask values of the field associated with PII, which in turn changes the output of the dataflow graph. Other examples include the use of metadata controls to automate the implementation of data quality rules, and the use of metadata to automate data ingestion, as described in U.S. patent application Ser. No. 18/496,543, titled “Meta-data driven ingestion and data processing,” the entire content of which is hereby incorporated by reference. Additional details regarding the use of metadata to control the execution and generation of computer programs are described in U.S. patent application Ser. No. 18/104,066, titled “Operationalizing metadata,” the entire content of which is hereby incorporated by reference.

When an application executes in accordance with the metadata (and, in some cases, the technical data) in a particular source environment, that metadata (and technical data) should be promoted to a target environment to ensure that the application executes as intended in the target environment. In general, promoting metadata includes transferring the metadata from a metadata repository of a source environment to a target environment, and loading (e.g., inserting, updating, or deleting) the metadata into a metadata repository of the target environment. Similarly, promoting technical data includes transferring the technical data from a technical repository of a source environment to a target environment, and loading the technical data into a technical repository of the target environment. Note that source and target are relative terms, and an environment might function as a source environment in one promotion and a target environment in another.

Due to the involvement of multiple developers and other stakeholders in the development process, it is often impractical to promote all the metadata and technical data relied on by an application at once. Promoting all the metadata and technical data relied on by an application at once may also lead to peak demands in computational resources required for that operation per unit of time, which should be avoided to have a lower and more homogeneous demand for computational resources per unit time. However, portions of the metadata and technical data relied on by the application can change over time due to the continuous nature of application development. Thus, piecemeal promotion of portions of the metadata and technical data for an application can result in incompatibilities and other errors that hinder proper application development.

The techniques described here ensure proper development (e.g. testing) of applications across different technical environments, while keeping the computational efforts moderate and allowing for multiple stakeholders to be involved in the development process. A collection of metadata (and related technical data) can be created and promoted between different environments in an efficient and easy manner. In particular, specific versions of metadata entities to include in a collection can be specified in a source environment. A data processing system can then add the specified versions of the entities (or references to the specified versions of the entities) to a named collection referred to herein as a version tag. The data processing system can also automatically identify a specific version of one or more other (metadata) entities that are related (e.g., via a schema or model) to the entities specified for the collection, and can add these related entities (or references to these related entities) to the version tag. In this way, the version tag includes (or references) both the specified entities and the related entities, thereby reducing errors during promotion due to missing dependencies or references among the data and/or application.

Once created, the version tag and its associated entities can be promoted from the source environment (e.g., an application development environment) to a target environment (e.g., an application test environment). During promotion, a data processing system can automatically identify technical data in the source environment that is related to the entities in the version tag, and can include the identified technical data in the promotion to the target environment. For example, the data processing system may automatically identify data obfuscation logic in the source environment that is related to particular fields in a dataset as identified by the metadata in the version tag and can include the identified obfuscation logic in the promotion to the target environment. Before loading the version tag, the entities, and the technical data into the target environment, one or more validations can be performed on the promoted metadata and technical data to identify potential issues that the metadata and/or technical data would cause within the target environment. Information about the issues can be presented to a user or system to facilitate correction of the issues prior to loading the metadata and the technical data into the target environment. Through these techniques, the quality and completeness of metadata (and technical data) that is promoted between the source environment and the target environment is improved.

In general, in a first aspect, a method performed by a data processing system for improving quality of metadata transferred between environments executing one or more applications in accordance with the metadata includes: storing, in a data repository of a source environment, entities including metadata specifying one or more attributes of data accessible by the source environment; storing, in the data repository, a schema specifying relationships among the entities, generating an identifier representing a collection of entities; receiving a request to include a specified entity in the collection; responsive to the request, associating the specified entity with the identifier to represent the specified entity being included in the collection; identifying, based on the schema, one or more other entities related to the specified entity; and associating the one or more other entities with the identifier to represent the one or more other entities being included in the collection; receiving a request to transfer the collection of entities to a target environment; responsive to the request, applying one or more validation rules of the target environment to entities associated with the identifier representing the collection to be transferred to the target environment to determine whether the entities satisfy one or more criteria of the validation rules; and, if the entities associated with the identifier representing the collection to be transferred to the target environment satisfy the one or more criteria of the validation rules, transferring the entities to the target environment, with the transferred entities corresponding to the entities associated with the identifier.

In general, in a second aspect, a method performed by a data processing system for delivering a dynamically identified set of related metadata of a specified quality to a target environment for metadata-driven processing of data includes: in a source environment, dynamically identifying a related set of metadata including given metadata and metadata related to the given metadata, by: receiving an indication of given metadata of the source environment; accessing a schema specifying relationships among metadata of the source environment; and identifying, by the data processing system and based on the schema, metadata of the source environment related to the given metadata; processing, by the data processing system, identified metadata corresponding to the related set of metadata with one or more quality rules to determine whether the identified metadata has a specified quality; determining, by the data processing system, that the identified metadata has the specified quality; and in accordance with the identified metadata having the specified quality, making the identified metadata available for metadata-driven processing of data in the target environment.

In general, in a third aspect combinable with the first or second aspects, the method includes identifying one or more items of data associated with at least one of the specified entity or the one or more other entities; and retrieving, from a data repository, the one or more items of data.

In general, in a fourth aspect combinable with any of the first through third aspects, the one or more validation rules are first validation rules, and the method includes: applying one or more second validation rules of the target environment to the items of data to determine whether the items of data satisfy one or more criteria of the second validation rules; and if the entities satisfy the one or more criteria of the first validation rules and if the one or more items of data satisfy the one or more criteria of the second validation rules, transferring the entities and the one or more items of data to the target environment.

In general, in a fifth aspect combinable with any of the first through fourth aspects, the one or more items of data include at least one of: a record format definition associated with the specified entity or the one or more other entities, or application logic associated with the specified entity or the one or more other entities.

In general, in a sixth aspect combinable with any of the first through fifth aspects, the method includes receiving an indication of a version for the specified entity.

In general, in a seventh aspect combinable with any of the first through sixth aspects, the method includes responsive to the request to include a specified entity in the collection, identifying one or more other entities related to the version of the specified entity; and associating the one or more other entities with the identifier to represent the one or more other entities being included in the collection.

In general, in an eighth aspect combinable with any of the first through seventh aspects, the method includes receiving an indication of a version for the identifier representing the collection of entities.

In general, in a ninth aspect combinable with any of the first through eighth aspects, transferring the entities to the target environment includes inserting the transferred entities into a data repository of the target environment, updating one or more values of entities in the data repository of the target environment based on the transferred entities, or deleting one or more of the entities in the data repository of the target environment based on the transferred entities.

In general, in a tenth aspect combinable with any of the first through ninth aspects, the method includes upon determining that at least one of the entities fail the one or more criteria of the validation rules, causing display of information regarding a cause of the failure.

In general, in an eleventh aspect combinable with any of the first through tenth aspects, the method includes responsive to the display of the information regarding the cause of the failure, receiving a request to include an additional entity in the collection; and associating the additional entity with the identifier to represent the additional entity being included in the collection.

In general, in a twelfth aspect combinable with any of the first through eleventh aspects, the method includes responsive to the display of the information regarding the cause of the failure, receiving an indication to override the failure; and responsive to the indication to override the failure, transferring the entities to the target environment.

In general, in a thirteenth aspect combinable with any of the first through twelfth aspects, the method includes upon determining that at least one of the entities fail the one or more criteria of the validation rules, aborting the transfer of the collection of entities to a target environment.

In general, in a fourteenth aspect combinable with any of the first through thirteenth aspects, the one or more validation rules include at least one of a structural validation rule or a semantic validation rule, the structural validation rule including criterion for one or more references of the entities within the target environment to specify a required referential integrity, and the semantic validation rule including criterion for attributes of the entities.

In general, in a fifteenth aspect combinable with any of the first through fourteenth aspects, an application in the target environment is configured to execute in accordance with metadata included in the transferred entities.

In general, in a sixteenth aspect combinable with any of the first through fifteenth aspects, the method includes accessing, from a data repository of the target environment, an application; and executing the application in accordance with metadata included in the transferred entities.

In general, in a seventeenth aspect combinable with any of the first through sixteenth aspects, identifying the one or more other entities related to the specified entity includes querying the data repository of the source environment in accordance with a related content query, the related content query being configured to select the one or more other entities based on the specified entity.

In general, in an eighteenth aspect combinable with any of the first through seventeenth aspects, associating the specified entity with the identifier to represent the specified entity being included in the collection includes associating a reference to the specified entity with the identifier.

In general, in a nineteenth aspect combinable with any of the first through eighteenth aspects, the method includes upon determining that the entities satisfy the one or more criteria of the validation rules, transferring the identifier representing the collection of entities to the target environment.

In general, in a twentieth aspect combinable with any of the first through nineteenth aspects, transferring the entities to the target environment includes generating an archive file including the transferred entities and the identifier.

In general, in a twenty-first aspect combinable with any of the first through twentieth aspects, the applying of the one or more validation rules of the target environment to entities associated with the identifier representing the collection to be transferred to the target environment to determine whether the entities satisfy one or more criteria of the first validation rules includes: determining that the transfer of the entities associated with the identifier representing the collection to be transferred would likely cause an error within the target environment by determining that at least one of: a) an entity within the target environment, b) a reference to an entity within the target environment, or c) a piece of application logic is not found that is needed for a successful integration into the target environment of the entities associated with the identifier representing the collection to be transferred

In general, in a twenty-second aspect combinable with any of the first through twenty-first aspects, the method includes: in response to the determining that the transfer of the entities associated with the identifier representing the collection to be transferred would likely cause an error within the target environment, aborting the transfer and outputting information regarding the error, the outputted information providing guidance on how to adapt the collection of entities to avoid the error.

In general, in a twenty-third aspect combinable with any of the first through twenty-second aspects, the method incudes: upon the outputting of the information, receiving a request to adapt the collection of entities in accordance with the guidance in the outputted information.

In general, in a twenty-fourth aspect combinable with any of the first through twenty-third aspects, the method includes: responsive to the request to adapt the collection of entities, adapting the collection of entities in accordance with the request to adapt the collection of entities; receiving a request to transfer the adapted collection of entities to the target environment; responsive to the request to transfer the adapted collection of entities, applying the one or more validation rules of the target environment to entities associated with the identifier representing the adapted collection to be transferred to the target environment to determine that the entities satisfy one or more criteria of the first validation rules; and upon determining that the entities associated with the identifier representing the adapted collection to be transferred to the target environment satisfy the one or more criteria of the validation rules, transferring the entities to the target environment, with the transferred entities corresponding to the entities associated with the identifier representing the adapted collection.

In general, in a twenty-fifth aspect combinable with any of the first through twenty-fourth aspects, the method includes: upon completing the transfer, using the transferred entities by an application within the target environment substantially in accordance with usage of the entities by the application in the source environment.

In general, in a twenty-sixth aspect combinable with any of the first through twenty-fifth aspects, the source environment is a development environment for an application and the target environment is a test environment or a production environment for the application.

In general, in a twenty-seventh aspect combinable with any of the first through twenty-sixth aspects, making the identified metadata available in the target environment includes: modifying a repository of the target environment such that the identified metadata is available for metadata-driven processing of data in the target environment.

In general, in a twenty-eighth aspect combinable with any of the first through twenty-seventh aspects, making the identified metadata available in the target environment includes: storing the identified metadata in a repository of the target environment.

In general, in a twenty-ninth aspect combinable with any of the first through twenty-eighth aspects, making the identified metadata available in the target environment includes: making the identified metadata accessible to one or more applications of the target environment.

In general, in a thirtieth aspect combinable with any of the first through twenty-ninth aspects, making the identified metadata available in the target environment includes: incorporating the identified metadata into a data catalog of the target environment.

In general, in a thirty-first aspect combinable with any of the first through thirtieth aspects, making the identified metadata available in the target environment includes: storing the identified metadata in a first state in a repository of the target environment, wherein the identified metadata is unavailable in the target environment when in the first state; receiving an indication to transition the identified metadata from the first state to a second state, wherein the metadata is available in the target environment when in the second state; and in response to the indication, transitioning the metadata to the second state.

In general, in a thirty-second aspect combinable with any of the first through thirty-first aspects, the method includes: identifying a version conflict among the metadata related to the given metadata, and causing display of information regarding the version conflict.

In general, in a thirty-third aspect combinable with any of the first through thirty-second aspects, the method includes: in response to the display of the information regarding the version conflict, receiving selection data specifying selection of a particular version for the metadata related to the given metadata, and including the particular version of the metadata related to the given metadata in the related set of metadata.

In general, in a thirty-fourth aspect combinable with any of the first through thirty-third aspects, the method includes: receiving data input into a user interface, the data specifying the source environment, the target environment, and instructions to transfer the related set of metadata from the source environment to the target environment.

In general, in a thirty-fifth aspect, a system includes: one or more processors and memory storing instructions executable by the one or more processors to perform the operations of any of the first through thirty-fourth aspects.

In general, in a thirty-sixth aspect, a computer-readable storage medium, such as a non-transitory computer-readable storage medium, stores instructions executable by one or more processors to cause the one or more processors to perform the operations of any of the first through thirty-fourth aspects.

One or more of the above aspects may provide one or more of the following advantages.

By the above mentioned validation, the accuracy and completeness of metadata (and technical data) that is transferred between the source environment and the target environment is improved without disrupting ongoing development of an application. This ensures proper development of applications across different technical environments. Furthermore, the above mentioned validation also allows for piecemeal transfer of portions of the metadata (and technical data), which can change over time due to the continuous nature of application development, between the environments. This is beneficial for the hardware to keep the computational resources involved per unit time low. This is also beneficial for application development in distributed settings, where multiple distributed stakeholders are involved in the application development. Further, application developers and other stakeholders do not need to suspend (or rush) application development in order to promote all of the metadata and technical data relied on by the application at once.

In addition, by versioning the tag itself, additional metadata and/or new versions of existing metadata can be added to the tag and promoted with reduced risk due to the ability to revert to an earlier, stable version of the tag.

Further, by automatically discovering metadata related to the metadata specified by a user and including that related metadata in the tag, the techniques described here obviate the error-prone process of manually identifying and promoting related metadata, thereby improving the quality (e.g., accuracy) and completeness of promoted metadata. The quality of promotion is also improved by automatically identifying and promoting technical data related to the metadata in a tag.

The techniques described here validate the promoted metadata and technical data prior to integration into the target system, thereby improving the quality of the promoted metadata (and technical data) and reducing errors within the target environment. If an error is detected, information about the error is provided to a user or system to guide the user or system to correct the error (even if the error is external to the system), which further improves the quality and completeness of promoted metadata. By reducing errors in the metadata (and technical data) loaded into the target environment, processing is improved and computational resources are conserved because there is a reduction in an amount of processing that starts or otherwise take places that has to be aborted or stopped due erroneous data, such as a missing dependency or a missing data item. In cases like these, the processing needs to be performed again once all of the required metadata (and technical data) is in the target environment. Thus, by ensuring that all of the required metadata (and technical data) is transferred to the target environment in the first instance, the techniques described here improve processing and application development while reducing consumption of computing resources.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1B are block diagrams of a system.

FIG. 1C is a diagram illustrating an example of metadata tagging and promotion.

FIG. 1D is a diagram of an example system for metadata tagging and promotion.

FIG. 2 is a diagram illustrating an example of metadata tagging and promotion.

FIGS. 3A-3F are diagrams of the system of FIG. 1D in stages of metadata tagging and promotion.

FIGS. 4A-4C are diagrams illustrating an example metadata tagging and promotion with external promotion.

FIGS. 5A-5B are diagrams of the system of FIG. 1D in stages of metadata tagging and promotion.

FIGS. 6A-6C are diagrams of an example system for metadata tagging and promotion.

FIGS. 7-8 are flow diagrams of example processes for metadata tagging and promotion.

FIG. 9 is a diagram illustrating an example computing system.

### DETAILED DESCRIPTION

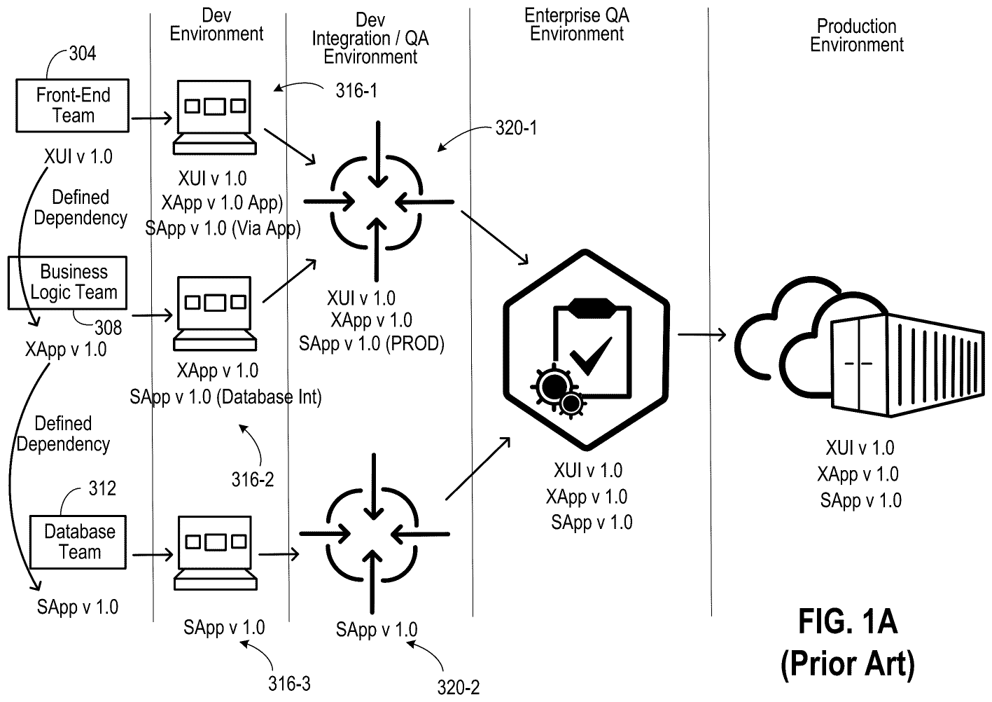

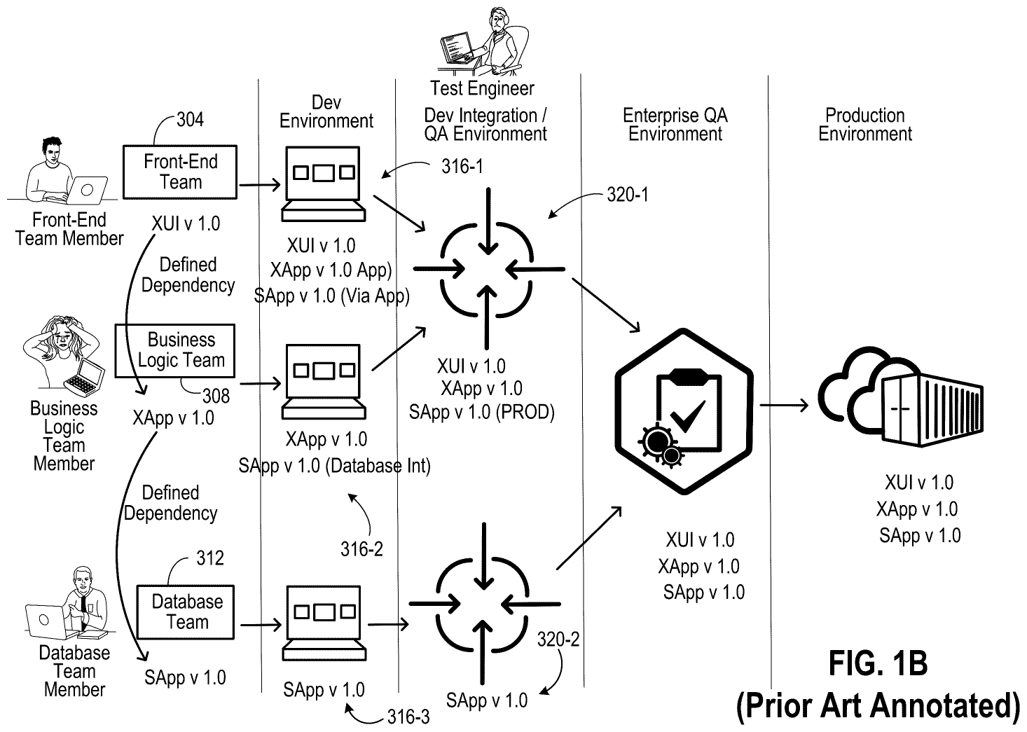

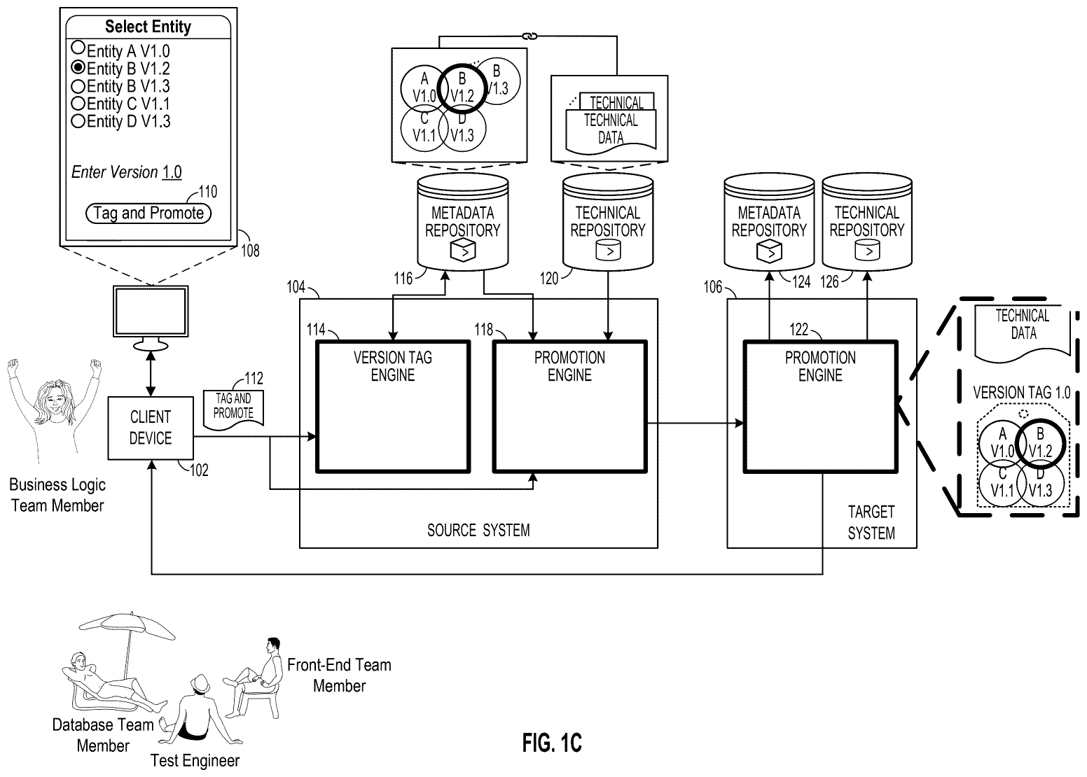

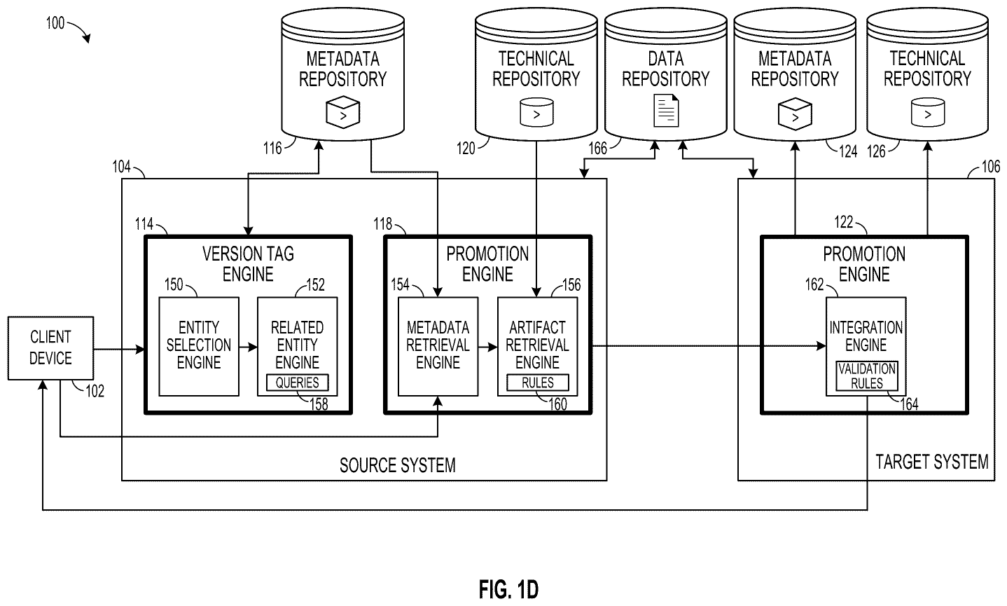

Referring to FIG. 1C, an example of metadata tagging and promotion is shown. In this example, a user (e.g., a non-technical business user) interacts with a client device 102 to create a version tag with specific versions of one or more selected metadata entities, and promote the version tag from a source system 104 (e.g., a source environment, such as a development environment) to a target system 106 (e.g., a target environment, such as a test environment).

As shown in the visualization 108, the user specifies the creation of a version tag having a version 1.0, and selects “Entity B V1.2” for inclusion in the version tag. From here, the user selects a “Tag and Promote” option 110 to send instructions 112 to the source system 104. Upon receipt of the instructions 112, a version tag engine 114 of the source system 104 creates the version tag (e.g., version tag 1.0), and associates the selected entity (e.g., Entity B V1.2) with the version tag. The version tag engine 114 also queries a metadata repository 116 of the source system 104 to identify, based on a schema or model, specific versions of other metadata entities that are related to the selected entity, and associates the related entities with the version tag. In this example, the version tag engine 114 identifies Entity A V1.0, Entity C V1.1, and Entity D V1.3 as being related to Entity B V1.2, and thus associates these related entities with version tag 1.0. The version tag engine 114 then stores the version tag in the metadata repository 116.

A promotion engine 118 of the source system 104 promotes the version tag and the metadata entities associated with the version tag to the target system 106 responsive to the instructions 112. In some examples, the promotion engine 118 can also promote technical data associated with the entities being promoted. In this example, the promotion engine 118 retrieves the version tag and the entities associated with the version tag from the metadata repository 116 of the source system 104. The promotion engine 118 then determines, based on the retrieved entities, whether any technical data should be promoted along with the retrieved entities. Here, the promotion engine 118 determines (e.g., based on predefined rules and/or relationships between the entities and the technical data) that an item of technical data associated with one of the retrieved entities should be promoted, and thus retrieves the item of technical data from a technical repository 120 of the source system 104. The promotion engine 118 then provides the version tag, the retrieved metadata entities associated with the version tag, and the retrieved item of technical data to a promotion engine 122 of the target system 106.

Once received, the promotion engine 122 of the target system 106 performs various validations on the received data to determine whether there are any errors or warnings associated with the promotion. If there are errors or warnings, guiding information regarding these validation issues is provided to the user to enable the user to correct (or override) the issues based on the guiding information. On the other hand, if there are no errors or warnings, the promoted version tag and metadata entities are loaded into a metadata repository 124 of the target system 106, and the promoted technical data is loaded into a technical repository 126 of the target system 106. Note that while the metadata and technical data are described as being stored in separate metadata and technical repositories, these repositories can be combined in some examples. Once loaded, applications, such as applications included in the promotion and/or applications already existing in the target system 106, can execute in accordance with the metadata. In this manner, a user (e.g., a non-technical business) is able to tag, in a self-service manner, specific, point-in-time versions of entities of interest and promote these entities without the need to collaborate and coordinate with other developers or testers.

Referring to FIG. 1D, an example system 100 for metadata tagging and promotion is shown. In this example, the system 100 includes the source system 104 and the target system 106. The source system 104 includes the version tag engine 114 having an entity selection engine 150 and a related entity engine 152. The source system 104 also includes the promotion engine 118 having a metadata retrieval engine 154 and an artifact retrieval engine 156.

In operation, the entity selection engine 150 receives, from the client device 102, a specification of specific versions of one or more entities for inclusion in a version tag. The entity selection engine 150 (and/or the version tag engine 114) can also receive a name or another identifier for the version tag, as well as a version for the version tag. For example, the entity selection engine 150 (or another component of the source system 104) can cause the client device 102 to display a graphical user interface that enables the user to input the tag name and the tag version, and to specify the versioned entities for inclusion in the tag (e.g., via selection of specific versions of one or more entities from a list of all entities and their respective versions). Once this information is received, the entity selection 150 engine adds the specified entities to the version tag, such as by including references to the specified entities in the version tag.

The version tag including the references to the specified entities is then passed to the related entity engine 152. The related entity engine 152 identifies specific versions of one or more other entities that are related to the specified entities. To do so, the related entity engine 152 can use one or more related content queries 158 to the metadata repository 116, as described herein. After identifying the related entities, the related entity engine 152 adds the related entities to the version tag (e.g., by including references to the related entities in the version tag). The entity engine 152 can also add to the tag information on how the tag came to be (e.g., the user that created or owns the tag, the related content queries that were executed to identify the related entities, etc.). The version tag including the specified entities and the related entities is stored in the metadata repository 116.

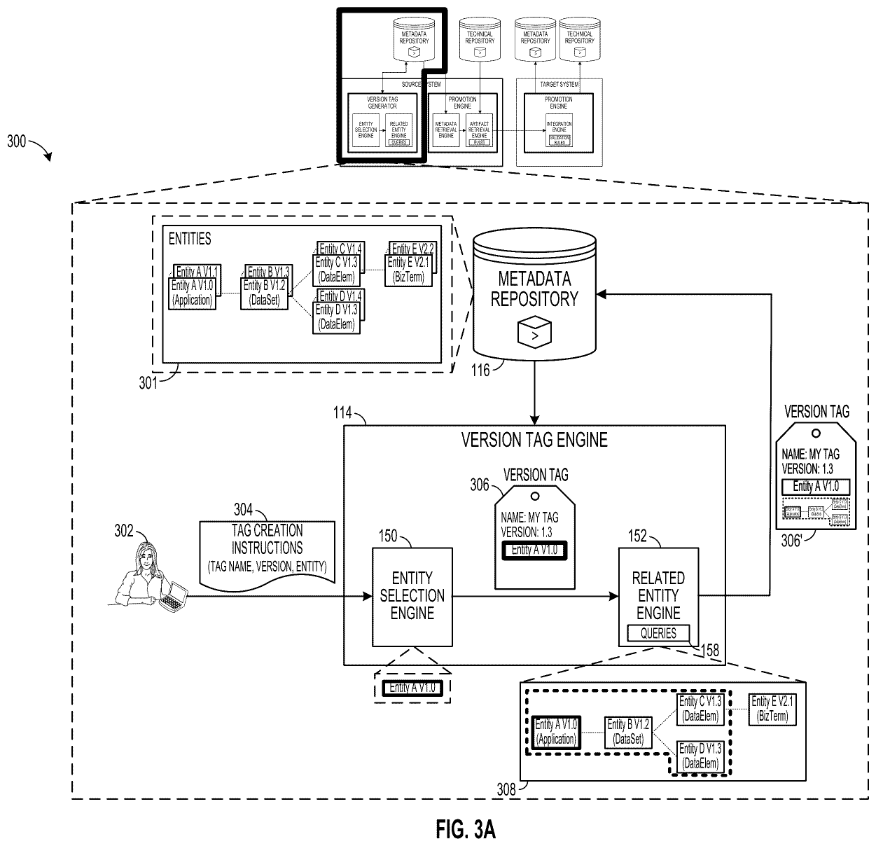

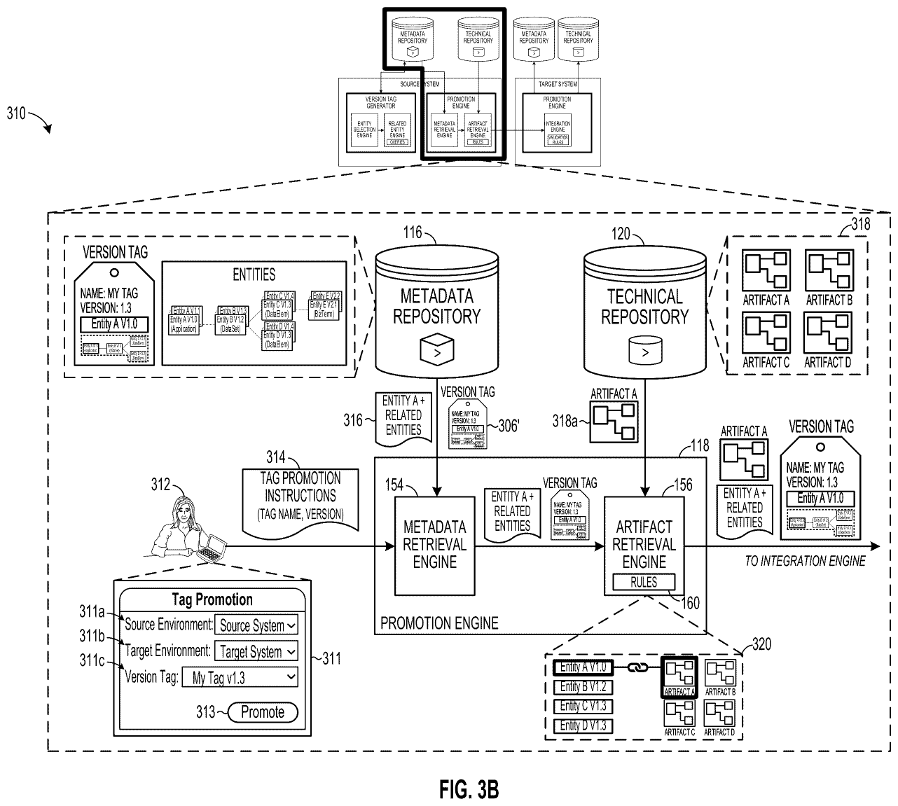

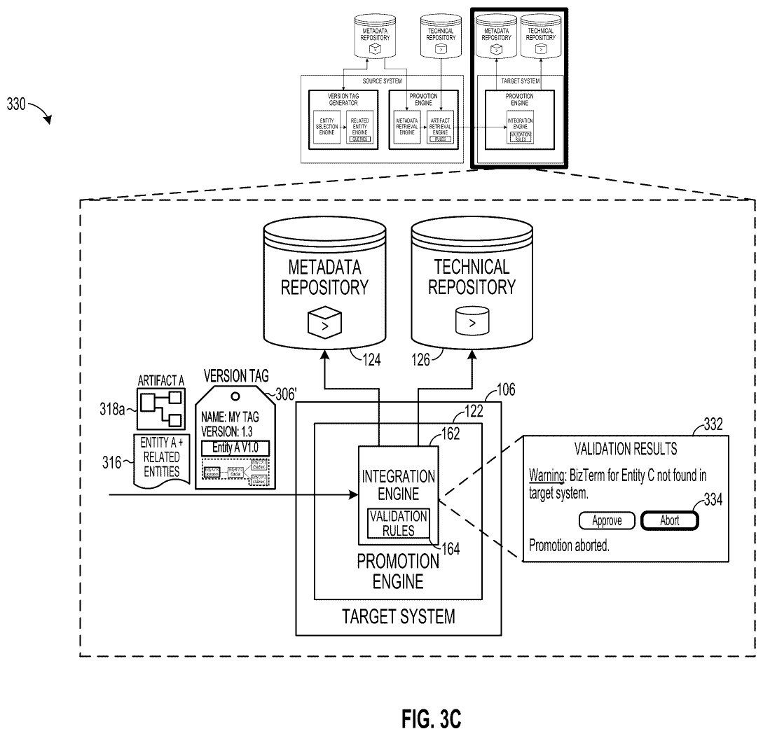

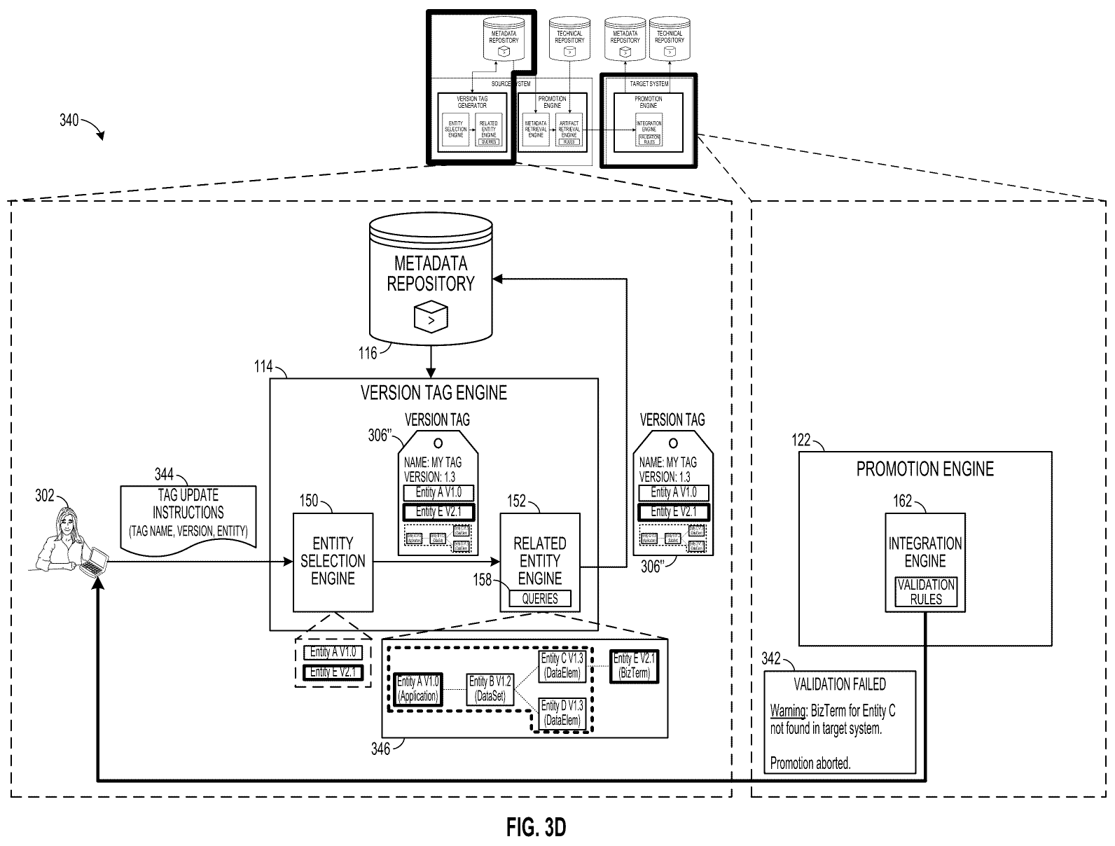

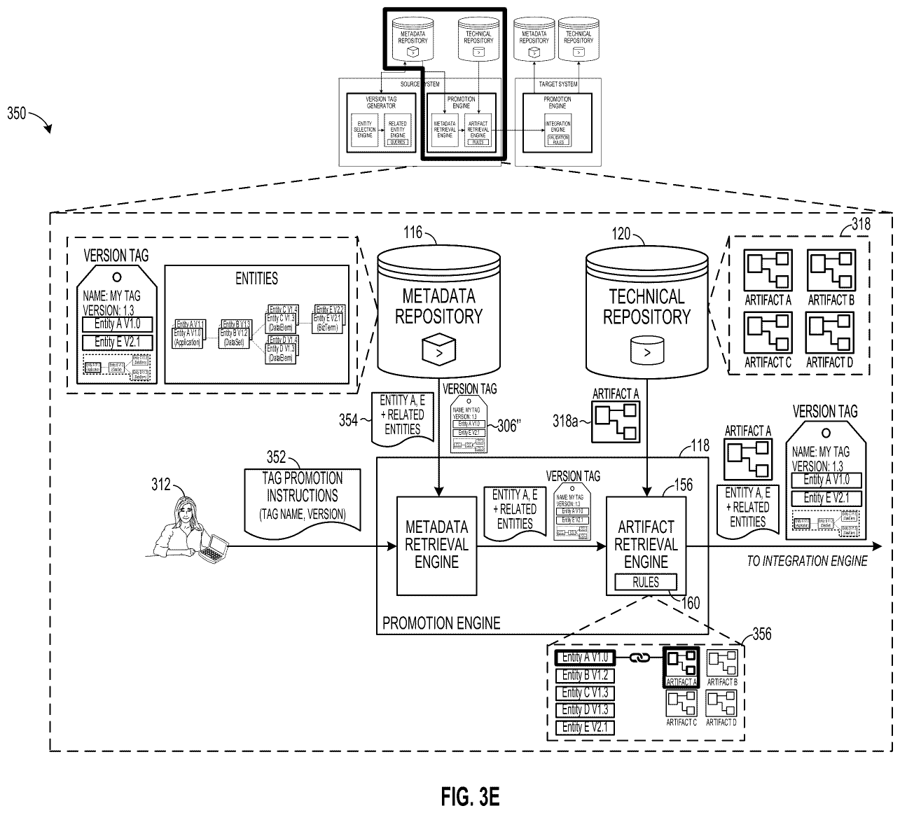

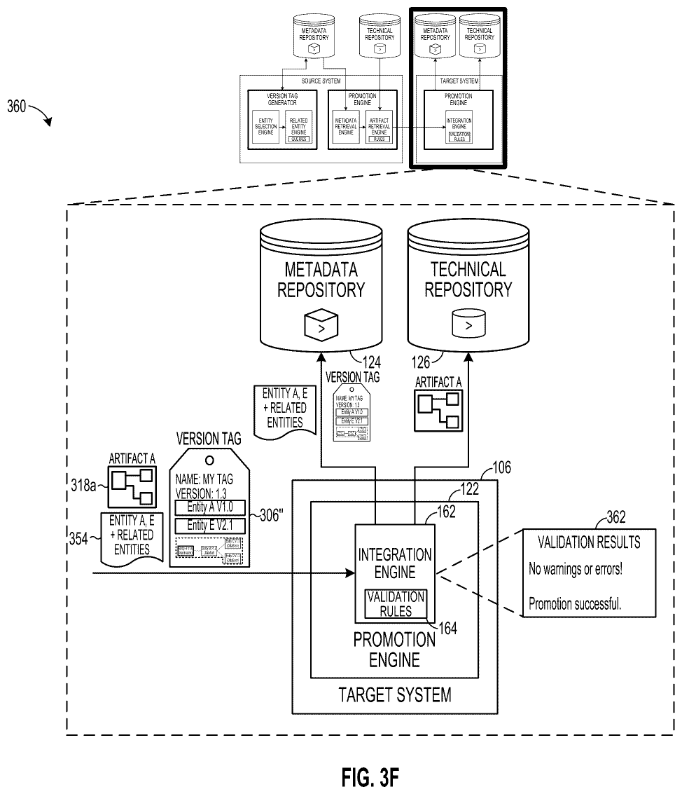

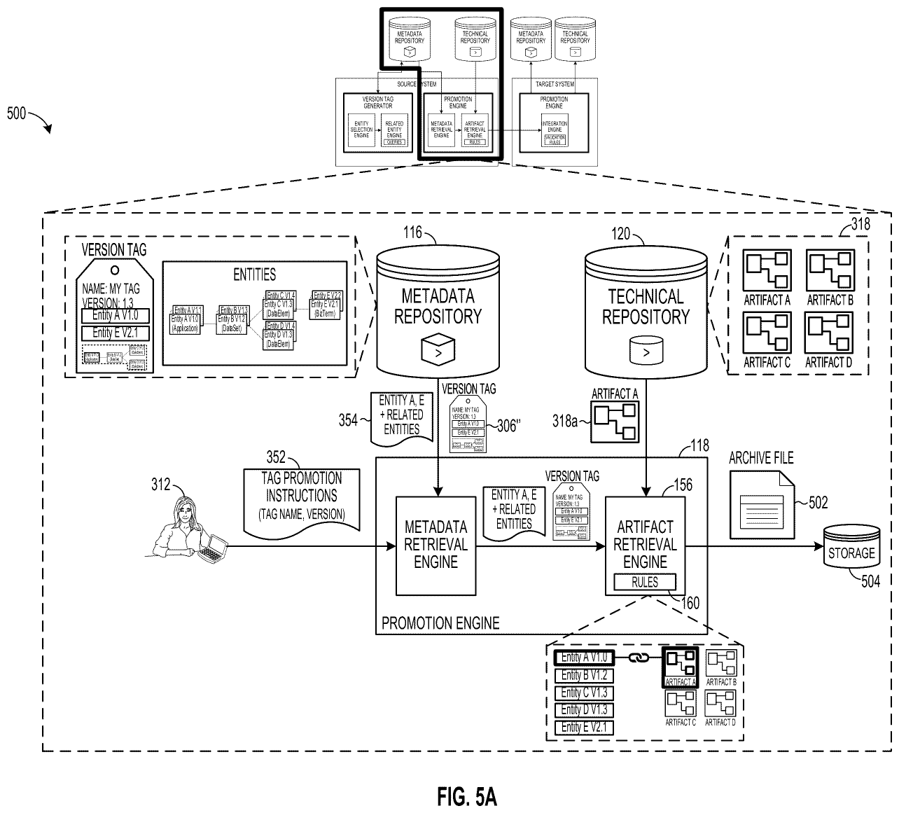

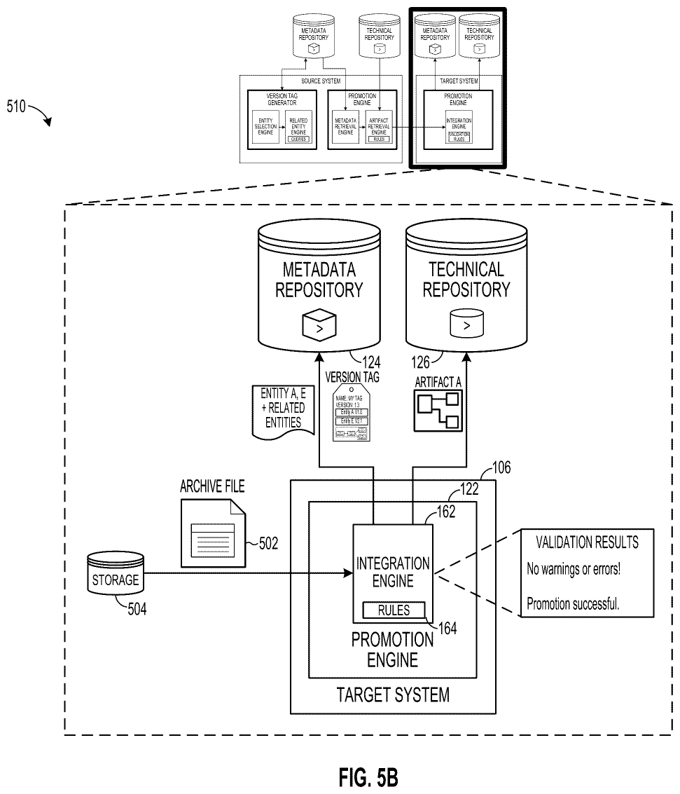

After the version tag is created, a user may decide to promote the version tag and its associated entities from the source system 104 to the target system 106. To do so, the user may use the client device 102 to send promotion instructions to the promotion engine 118. In some examples, these instructions include the name or another identifier for the version tag, as well as the version of the version tag to be promoted. The metadata retrieval engine 154 of the promotion engine 118 receives the instructions, retrieves the version tag and its associated entities from the metadata repository 116, and passes the version tag and the retrieved entities to the artifact retrieval engine 156. The artifact retrieval engine 116 identifies artifacts related or linked to the retrieved entities, and retrieves the identified entities from the technical repository 120 of the source system 104. The retrieved artifacts can include, for example, source code, executables, or other application logic associated with the retrieved entities, record format definitions associated with the retrieved entities, properties (e.g., scalar properties) of the retrieved entities, among other technical data associated with the retrieved entities. To identify the artifacts, the artifact retrieval engine can evaluate the retrieved entities in view of one or more pre-defined rules 160, as described herein. From here, the artifact retrieval engine 156 (and/or the promotion engine 118) promotes the version tag, the retrieved entities, and any retrieved artifacts to an integration engine 162 in the promotion engine 122 of the target system 106. Such a promotion can be either a consolidated promotion (in which metadata and data is directly transferred to the target system 106, as shown in FIG. 3C) or two-step promotion (in which metadata and data is transformed into an archive file, which is then loaded into the target system 106, as shown in FIGS. 5A-5B).

Upon receipt of the promoted version tag, entities, and artifacts, the integration engine 162 applies validation rules 164 (also referred to as quality rules) to the entities and artifacts (if any) to determine whether there would be any issues with integrating the entities and artifacts into the target system 106. For example, the integration engine 162 can determine whether there are any structural, semantic, or technical issues with the entities and artifacts within the target system 106, as described in detail below. If there are issues, the integration engine 162 can provide information about the issues to the client device 102 to facilitate correction of the issues before re-promotion. If there are no issues (or if the issues are overridable and a user chooses to override the issues), the integration engine 162 loads (e.g., inserts, updates, or deletes) the version tag and the entities into the metadata repository 124 of the target system 106, and loads the artifacts (if any) into the technical repository 126 of the target system 106. Once promotion is complete, the promoted version tag, entities, and artifacts can be used (e.g., by applications) within the target system 106 as they were in the source system 104.

For example, the source system 104 may execute an application that uses metadata of the source system 104 to drive the processing of data stored in a data repository 166 (e.g., by using metadata to refer to or control the processing of the data stored in the repository 166, among other examples). During development of the application, it may be necessary to have the target system 106 execute the application, such as to test the application (e.g., if the target system 106 is in a test environment) or provide the application's services to end users (e.g., if the target system 106 is in a production environment). However, the target system 106 cannot execute the application as intended without the metadata (and technical data) used to execute the application within the source system 104. By promoting the version tag, entities, and technical data as described herein, the target system 106 is able to execute the application (e.g., on the data stored in the data repository 166). Note that although a single data repository 166 shared by the source system 104 and target system 106 is shown, one or more separate data repositories can be used by the respective systems in some examples.

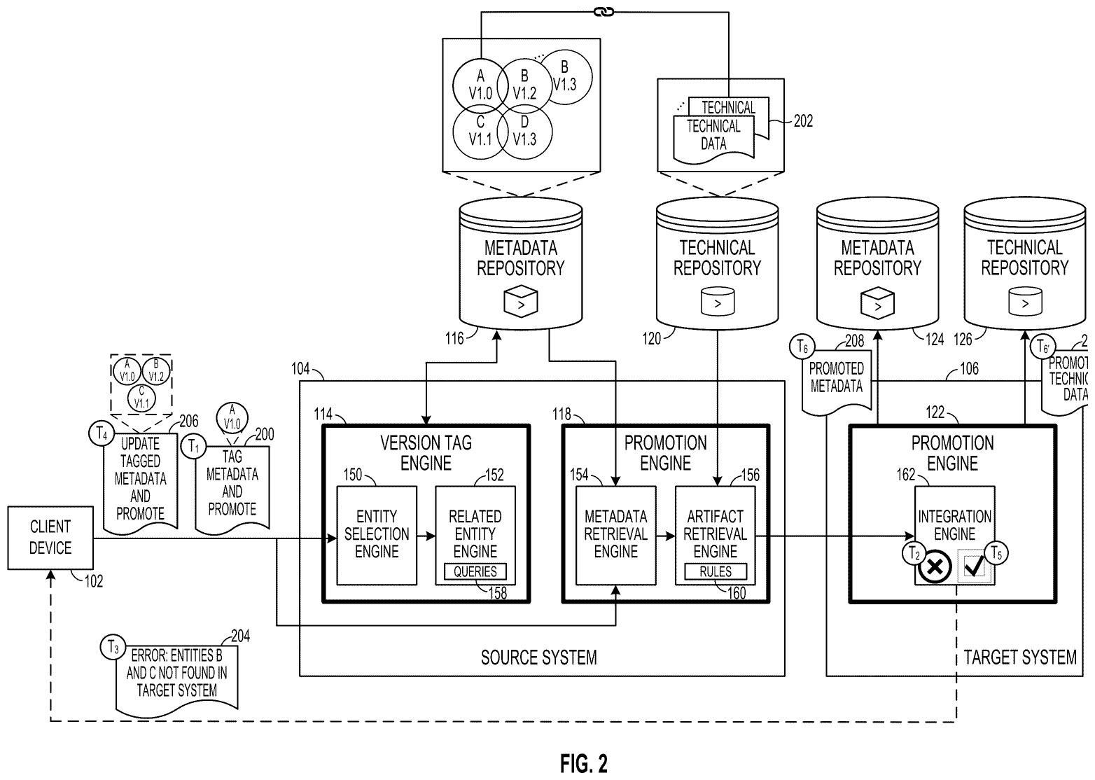

Referring to FIG. 2, another example of metadata tagging and promotion is shown. Initially, at time T₁, a user of the client device 102 sends instructions 200 to the source system 104 to create a version tag with entity A V1.0, and to promote the version tag. Responsive to the instructions 200, the entity selection engine 150 of the version tag engine 114 creates the version tag with the specified entity. The related entity engine 152 then determines (e.g., based on a schema or model) whether there are any entities related to the specified entity. In this example, the related entity engine 152 determines that there are no entities related to entity A V1.0, and thus stores the version tag with only the specified entity in the metadata repository 116.

The metadata retrieval engine 154 of the promotion engine 118 receives the instructions 200 to promote the version tag, and thus retrieves the version tag and entity A V1.0 from the metadata repository 116. The artifact retrieval engine 156 then determines whether there are any artifacts related to entity A V1.0 that should also be promoted. Here, the artifact retrieval engine 156 determines that an item of technical data 202 is linked or otherwise related to entity A V1.0. As a result, the artifact retrieval engine 156 retrieves the item of technical data 202 from the technical repository 120 and promotes the version tag, entity A V1.0, and the technical data 202 to the target system 106.

At time T₂, the integration engine 162 of the promotion engine 122 determines whether there are any issues associated with integrating the promoted entity A V1.0 and technical data 202 into the target system 106. In this example, the integration engine 162 determines (e.g., based on the application of one or more validation rules) that the promotion would cause an error within the target system 106, because entities B and C are not found within the target system and are needed for the successful integration of entity A and/or the technical data. As a result, the integration engine 162 aborts the promotion, and provides information 204 regarding the error to the client device 102 at time T₃, thereby guiding a user of the client device 102 to correct the error.

Responsive to the information 204, the user of the client device 102 sends updated instructions 206 to the source system 104 at time T₄ to update the version tag to include entity B V1.2 and entity C V1.1 (in addition to the previously specified entity A V1.0), and to promote the updated version tag. The entity selection engine 150 updates the version tag with the specified entities, and passes the updated version tag to the related entity engine 152. In this example, the related entity engine 152 determines that there are no entities related to the entities specified in the updated version tag, and thus stores the updated version tag in the metadata repository 116.

The metadata retrieval engine 154 receives the instructions 206 to promote the updated version tag, and thus retrieves the updated version tag and entities A V1.0, B V1.2, and C V1.1 from the metadata repository 116. The artifact retrieval engine 156 then determines whether there are any artifacts related to entities A V1.0, B V1.2, and C V1.1 that should also be promoted. Here, the artifact retrieval engine 156 determines that the item of technical data 202 is the only related artifact, and thus retrieves the item of technical data 202 from the technical repository 120. The artifact retrieval engine 156 then promotes the version tag, entities A V1.0, B V1.2, and C V1.1, and the technical data 202 to the target system 106.

At time T₅, the integration engine 162 of the promotion engine 122 determines whether there are any issues associated with integrating the promoted entities A V1.0, B V1.2, and C V1.1 and technical data 202 into the target system 106. In this example, the integration engine 162 determines (e.g., based on the application of one or more validation rules) that the promotion would not cause any errors. As a result, the integration engine 162 loads the promoted metadata 208 (e.g., the version tag and entities A V1.0, B V1.2, and C V1.1) into the metadata repository 124 at time T₆, and loads the promoted technical data 210 (e.g., technical data 202) into the technical repository 126 at time T_{6′}.

Referring to FIG. 3A, a view 300 depicting an example of metadata tagging is shown. In general, the metadata repository 116 can store entities 301 that each include metadata specifying attributes of an item of physical or logical data, such as an application, a dataset, a data element, or a business term, among others. Each entity 301 can also include a version, as values of the attributes of the entity can change over time. A schema or model can define relationships among the entities 301. For example, the schema or model may specify that Entity B V1.2, which represents a dataset, is related to (e.g., contains) Entity C V1.3 and Entity D V1.3, each of which represent a data element. In some examples, the schema or model may more generally specify that a dataset relates to (e.g., contains) one or more data elements, and the specific relationships can be defined by references within the entities themselves.

In this example, a user 302 provides (e.g., via a client device) tag creation instructions 304 to the entity selection engine 150. The tag creation instructions 304 can include, for example, a tag name, a tag version, and a specification of one or more entities for inclusion in the tag. In this example, the user 302 has specified in the instructions 304 a tag name of “My Tag” and a tag version of 1.3, and has further specified Entity A V1.0 for inclusion in the tag. Responsive to the instructions 304, the entity selection engine 150 creates a version tag 306, and transmits the version tag 306 to the related entity engine 152.

The related entity engine 152 executes one or more related content queries 158 to identify specific versions of entities related to the entities specified by the user 302. For example, if an entity representing an application is specified for inclusion in a version tag, it may be desirable to also include in the version tag all entities representing datasets that are related to that application, as well as all entities representing data elements that are related to those datasets. As such, a related content query 158 may specify a query that retrieves all entities representing datasets that are related to a particular application entity, as well as all entities representing data elements that are related to the retrieved dataset entities. Such a query is visually depicted in visualization 308, in which the bolded line represents the entity specified by the user 302, and the dashed line represents the related entities retrieved by the related content query 158. Here, the related entity engine 152 receives Entity B V1.2, Entity C V1.3, and Entity D V1.3 as a result of the query, and thus adds these entities to the version tag 306′ and stores the version data 306′ in the metadata repository 116. By automatically identifying and adding entities that are related to the entities specified in the version tag, the related entity engine 152 obviates the error-prone process of manually identifying and adding related entities, thereby improving the quality and completeness of promoted metadata.

Referring to FIG. 3B, a view 310 depicting an example of metadata promotion is shown. In this example, a user 312 (who may be the same as or different from user 302) transmits tag promotion instructions 314 to the metadata retrieval engine 154. For example, the user 312 can access a promotion interface 311 that enables the user to select or otherwise specify a source environment 311a for the promotion, a target environment 311b for the promotion, and a version tag 311c to be promoted from the source environment to the target environment. In some examples, values of one or more of the elements of the promotion interface 311 can be prepopulated or filtered to help guide the user 312 through the promotion process. For instance, in some examples, the source environment 311a can be prepopulated with the environment in which the user 312 is currently working. Further, in some examples, the target environment 311b and/or the version tag 311c can be filtered based on the selected source environment 311a.

In this example, the user 302 specifies that the source environment 311a for the promotion is the source system 104, the target environment 311b for the promotion is the target system 106, and that the version tag 311c to be promoted is “My Tag v1.3” (the version tag 306′). After specifying the source environment, target environment, and version tag, the user 312 can select the promote button 313 to transmit the tag promotion instructions 314 to the metadata retrieval engine 154. The tag promotion instructions 314 can include, for example, data specifying the selected source environment, the target environment, and the tag name and version. Responsive to the instructions 314, the metadata retrieval engine 154 retrieves the version tag 306′ and its associated entities 316 from the metadata repository 116, and transmits this data to the artifact retrieval engine 156.

The artifact retrieval engine 156 evaluates the entities 316 in accordance with one or more pre-defined rules 160 to determine whether any artifacts 318 in the technical repository should be promoted along with the entities 316. In general, the pre-defined rules 160 may specify which artifacts to promote for a given entity type (e.g., application, dataset, data element, or business term, among others). For example, a pre-defined rule 160 may specify that (particular) source code, executables, properties, or other application logic should be promoted along with an (particular) application entity. As another example, a pre-defined rule 160 may specify that a record format definition should be promoted along with a dataset entity. Information for locating the artifacts to be promoted can be specified in the entities 316, encoded within the artifact retrieval engine 156, or a combination thereof. In this example, the artifact retrieval engine 156 determines that artifact A 318a should be promoted along with Entity A V1.0, as shown in the visualization 320. As such, the artifact retrieval engine 156 retrieves artifact A 318a, and then promotes the version tag 306′, the entities 316, and artifact A 318a to the integration engine of the target system. In some examples, the artifact retrieval engine 156 can also identify, retrieve, and promote a particular version of artifacts.

Referring to FIG. 3C, a view 330 depicting an example of metadata promotion is shown. In this example, the integration engine 162 of the target system 106 receives the version tag 306′, the entities 316, and artifact A 318a from the source system. The integration engine 162 then applies one or more quality or validation rules 164 to validate the entities 316 and the artifact A 318a prior to integration into the target system 106.

In general, the validations performed by the integration engine 162 and defined by the validation rules 164 can include, for example, structural validation, semantic validation, and technical validation. Success of these validations can be required or optional. Required validations check for items of metadata and/or technical data that must be present for a successful promotion. If a required validation fails, the integration engine 162 can abort the promotion and indicate the error. Optional validations check for items of metadata and/or technical that should be present, but are not strictly necessary for a successful promotion. If an optional validation fails, the integration engine 162 can show a warning and give the user the ability to accept the warning (and proceed with promotion or partial promotion), or abort the promotion. While FIG. 3C depicts the target system 106 applying the validation rules 164 on the entities and artifacts prior to integration into the target system 106, in some examples the validation rules 164 can be applied by, for example, the promotion engine 118 of the source system 104 prior to transfer and integration of the entities and artifacts into the target system 106.

In some examples, structural validations specified by the validation rules 164 can be classified as required or optional. A required structural validation rule 164 may specify a required referential integrity, such as a promoted data element entity requiring a reference (e.g., a foreign key) to a dataset entity within the target system 106. An optional structural validation rule 164 may specify an optional referential integrity, such as a data element optionally requiring a reference (e.g., foreign key) to a business term within the target system 106.

Similarly, semantic validations specified by the validation rules 164 can be classified as required or option. A required semantic validation rule 164 may specify a required format for data or metadata, such as SSN must be of format ###-##-####. An optional semantic validation rule 164 may specify an optional requirement for data or metadata, such as a business term entity optionally requiring a description longer than 15 characters.

In some examples, technical validations specified by the validation rules 164 are required validations. For example, a required technical validation rule 164 may require that all dependent artifacts be promoted for a promoted artifact.

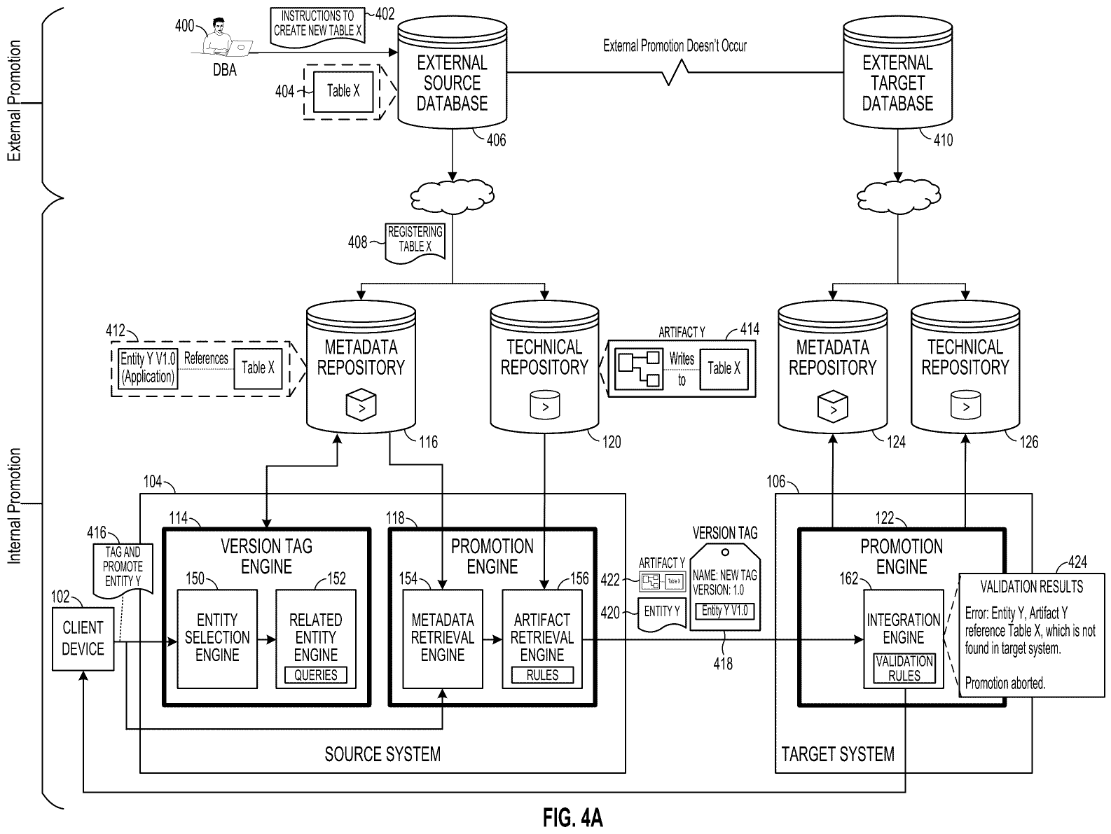

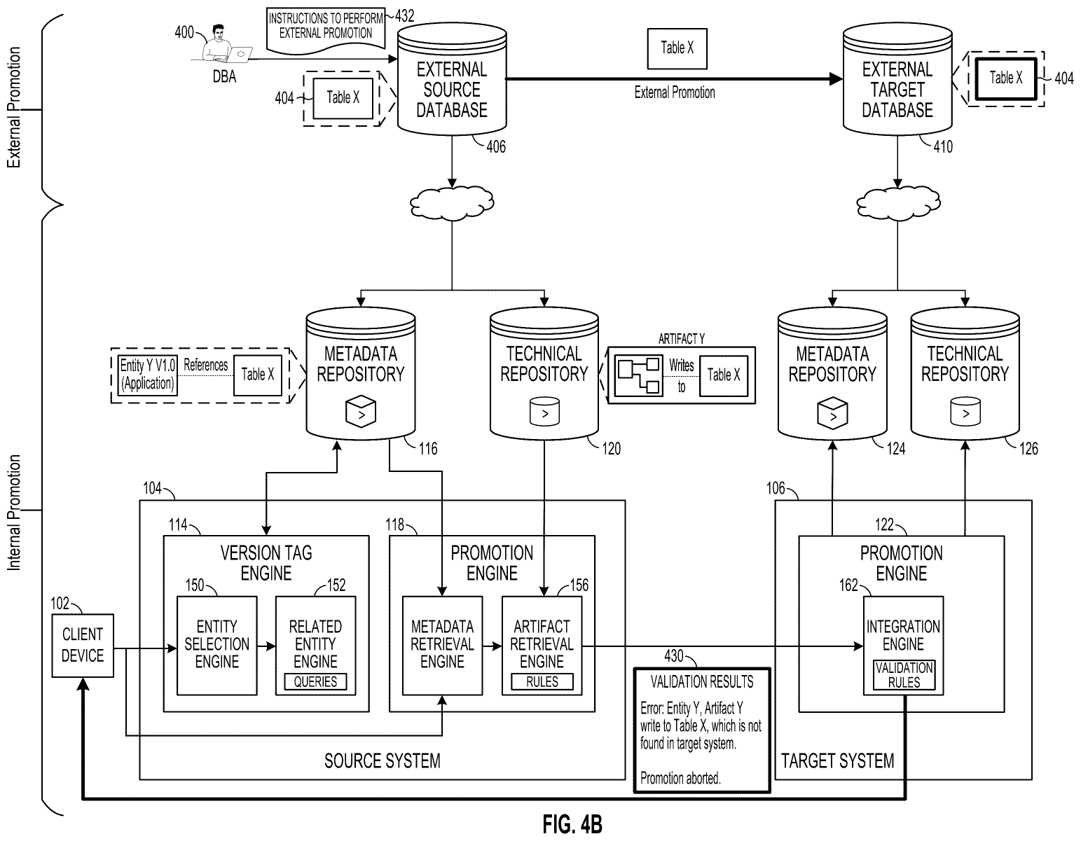

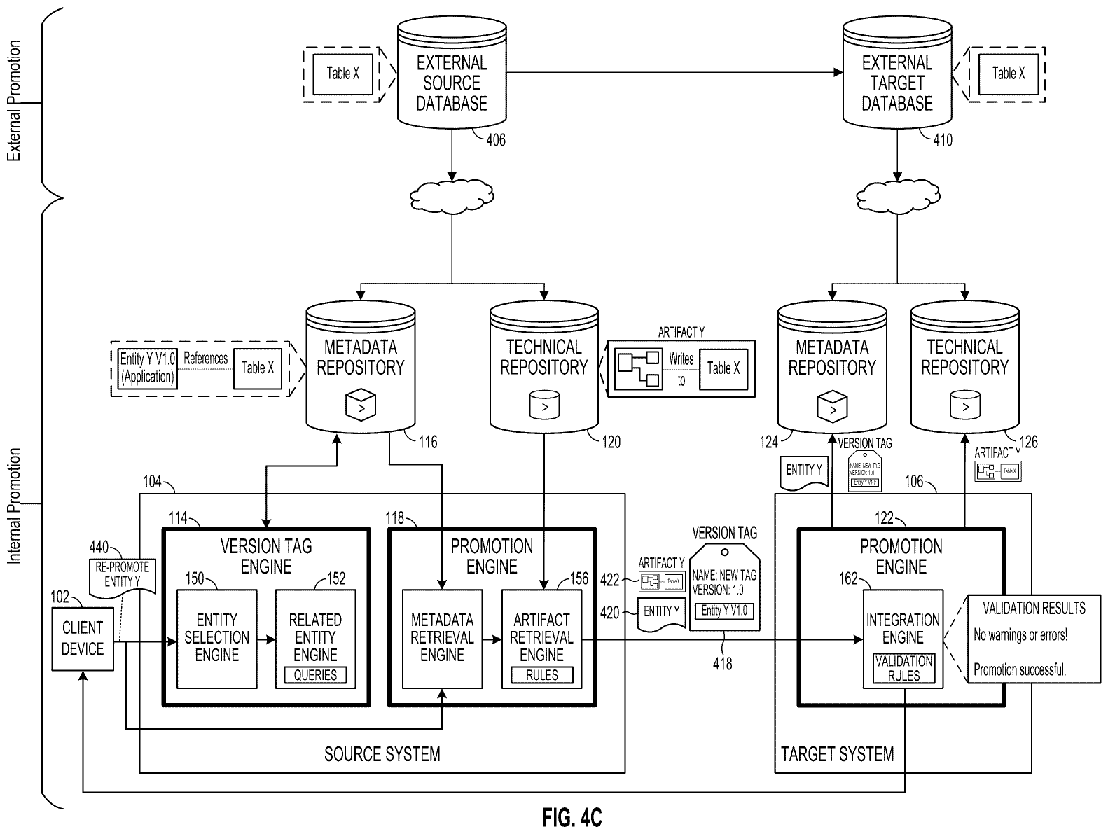

While specific validations are described herein, the integration engine 162 may be configured to perform additional or alternative validations in some examples without departing from the scope of the present disclosure. For instance, the integration engine 162 may be configured to detect conflicts due to external promotions, such as described with reference to FIGS. 4A-4C.

In this example, the integration engine 162 determines that the promoted metadata entities do not satisfy the criteria of the validation rules 164. Specifically, the integration determines 162 that the business term for promoted Entity C V1.3 is not found within the target system 106, as shown in validation results 332. Since the failed validation is an optional structural validation, the integration engine 162 warns the user and gives the user an option to approve the validation failure and proceed with the promotion, or abort the promotion. In this example, the user opts to abort the promotion by selecting the abort option 334.

After the promotion is aborted, the integration engine 162 provides information 342 about the failed validation to the user 312, as shown in view 340 in FIG. 3D. This information 342 guides the user to the root cause of the failed validation and provides information that enables the user to correct the error so that promotion is successful. Responsive to the information 342, the user 312 transmits tag update instructions 344 to the entity selection engine 150. In this example, the instructions 344 specify the tag name, the tag version, and specify that Entity E V2.1 is to be added to the tag (in addition to the existing entities). In response, the entity selection engine 150 generates an updated version tag 306″ with a reference to Entity E V2.1, and transmits the updated version tag 306″′ to the related entity engine 152. The related entity engine 152 determines that there are no additional related entities to add to the tag for Entity E V2.1 as depicted in visualization 346. As such, the related entity engine 152 stores the version tag 306″ in the metadata repository 116 without further change.

In some examples, the related entity engine 152 may determine that there are additional related entities to add to the tag for Entity E V2.1. For example, the related content queries 158 may include a query that retrieves all entities representing data elements that are related to the retrieved BizTerm entity (Entity E V2.1). As a result, the related entity engine 152 may retrieve Entity C twice: a first time when executing the related content query to retrieve entities related to Entity A V1.0, and a second time when executing the related content query to retrieve entities related to Entity E V2.1. Such a scenario can lead to a version conflict in which two different versions of Entity C are retrieved for inclusion in the version tag. For instance, Entity C V1.3 can be retrieved as a result of the related content query for Entity A V1.0, while a different version, such as Entity C V1.2, can be retrieved as a result of the related content query for Entity E V2.1. Similar version conflicts can also arise in situations where a particular version of an entity is tagged by a user, and another version of the entity is retrieved via a related content query.

In multiple versions of the same entity are included in a version tag, issues can arise if that tag is promoted to the target system. To prevent these issues, the version tag engine 114 can detect instances where multiple versions of the same entity are included in a version tag, and can guide a user to correct the version conflict. In some examples, when a version conflict is detected, the version tag engine 114 can provide information about the version conflict to the user (e.g., the user 312). For instance, continuing with the above example, the version tag engine 114 can cause a client device operated by the user to display a user interface with an indication that two different versions of Entity C (e.g., Entity C V1.2 and Entity C V1.3) have been added to the version tag. In some examples, the interface can also indicate how the two different versions were brought into the tag. The interface can also guide the user to correct the version conflict. For example, the interface can enable the user to select one version of the entity to include the tag (e.g., Entity C V1.2 or Entity C V1.3, in the above example). In some examples, the interface can enable the user to select a different version of the entity to resolve the version conflict, such as a different particular version (e.g., Entity C V1.4), or a version of the entity as of a particular date (e.g., Entity C as of Jan. 2, 2024, or as of today, etc.). In some examples, the interface can also enable the user to change the versions of some or all of the other entities included in the tag. For example, the user interface can enable the user to specify or otherwise change the version of a particular entity (e.g., change Entity B V1.2 to Entity B V1.3), or to set the version of some or all of the entities to their respective versions as of a particular date. By detecting and resolving version conflicts among entities in the tag, the version tag engine 114 improves the quality of tagged metadata before it is promoted.

Referring to FIG. 3E, a view 350 depicting an example of metadata promotion is shown. In this example, the user 312 transmits tag promotion instructions 352 to the metadata retrieval engine 154. Much like FIG. 3B, the tag promotion instructions 352 include, for example, the tag name (e.g., “My Tag”) and the tag version (e.g., 1.3). Responsive to the instructions 352, the metadata retrieval engine 154 retrieves the version tag 306″ and its associated entities 354 from the metadata repository 116, and transmits this data to the artifact retrieval engine 156.

The artifact retrieval engine 156 evaluates the entities 316 in accordance with one or more pre-defined rules 160 to determine whether any artifacts 318a-318d in the technical repository should be promoted along with the entities 316. Here, the artifact retrieval engine 156 determines that only artifact A 318a should be promoted along with Entity A V1.0, as shown in the visualization 356. As such, the artifact retrieval engine 156 retrieves artifact A 318a, and then promotes the version tag 306″, the entities 354, and artifact A 318a to the integration engine of the target system.

Referring to FIG. 3F, a view 360 depicting an example of metadata promotion is shown. In this example, the integration engine 162 of the target system 106 receives the version tag 306″, the entities 354, and artifact A 318a from the source system. The integration engine 162 then applies one or more validation rules 164 to validate the entities 354 and the artifact A 318a prior to integration into the target system 106. In this example, the integration engine 162 determines that the promoted metadata entities 354 and artifact A satisfy the criteria of the validation rules 164. As such, the integration engine 162 loads (e.g., inserts, updates, or deletes) the version tag and the entities 354 into the metadata repository 124 of the target system 106, and loads artifact A 318a into the technical repository 126 of the target system 106. Once promotion is complete, the promoted version tag, entities, and artifacts can be used (e.g., by applications) within the target system 106 as they were in the source system 104. In some examples, the promoted version tag, entities, and artifacts can be initial added to the target system 106 in a pending state, and can become available for use within the target system 106 after transitioned to an approved state according to an approval process.

In some examples, promoting (e.g., transferring and loading) the version tag, the entities, and the artifacts can include enabling or otherwise making available the version tag, the entities, and the artifacts available to one or more applications executed by the target system 106. For example, the entities (and/or the technical data) can be incorporated into a data catalog of the target system 106 such that the entities (and/or the technical data) are available within the data catalog (and, thus, available to applications in the target system 106 that use the data catalog). Incorporating the entities (and/or the technical data) into the data catalog can include, for example, connecting the entities (and/or the technical data) with other entities (and/or the technical data) according to relationships specified in a schema or model, or in the entities and data itself. In some examples, certain relationships, references, or links of the promoted version tag, entities, and artifacts in the source system can be updated for the target system (e.g., to update storage locations).

In some examples, the promotion engine 118 of the source system 104 and/or the promotion engine 122 of the target system 106 can maintain a record or audit log of promotions. Such a log can include information regarding the initiated promotions (e.g., date initiated, user who initiated, etc.), the promoted version tag, entities, and artifacts, and whether the promotion was successful, among other information. Such a record or audit log can help identify the root cause of issues during promotion, and can also facilitate governance of the promoted data. In some examples, a hash function (e.g., a secure hash algorithm (SHA)) can be used to ensure the integrity of the promoted data.

In some examples, the version tag generator 114 of the source system 104 can perform tag differencing. For example, the version tag generator 114 can provide a user interface for enabling a user to select two different versions of a tag. The version tag generator 114 can then process the two different versions of the tag to identify differences among the two tags, such as differences among entities, entity versions, and entity relationships, among others, and can display information regarding the differences in the user interface. In some examples, the version tag generator 114 can also identify and display differences between the entities in a particular version of a tag and entities stored in the metadata repository as of a particular instance in time. Such differencing information enables the user to understand changes in the tag and the metadata entities as a whole.

Referring to FIG. 4A, an example of metadata tagging and promotion with external promotion is shown. In this example, a database administrator (DBA) 400 transmits instructions 402 to create a new Table X 404 within an external database 406 of the source system 104. After Table X 404 is created in the external database 406 of the source system, Table X is registered 408 within the metadata repository 116 (e.g., as a metadata entity within the metadata repository 116). Notably, Table X 404 is not promoted to the external database 410 of the target system (e.g., due to external promotion not being initiated by the DBA 400).

At some point in time, an application Y is developed within the source system 104 that references Table X. As a result, a metadata Entity Y V1.0 representing application Y (which references Table X) is stored in the metadata repository 116, as shown in visualization 412. In addition, an artifact Y that writes to Table X is stored within the technical repository 120, as shown by visualization 414.

In this example, instructions 416 are received from client device to create a version tag with Entity Y V1.0, and to promote the version tag from the source system 104 to the target system 106. Responsive to the instructions, the source system 104 creates and promotes a version tag 418 (e.g., “New Tag V1.0”), Entity Y V1.0 420, and artifact Y 422 to the target system 106. However, the integration engine 162 of the target system 106 determines that there is a fatal error 424 with the promotion, as Entity Y V 1.0 and artifact Y both reference Table X, which is not found in the target system 106. This is because the external promotion to promote Table X from the external database 406 of the source system 104 to the external database 408 of the target system 106 has not occurred.

Referring to FIG. 4B, validation results 430 are provided to the client device 102 to inform a user of the client device 102 of the failed promotion and the reason for the failed promotion. In response, the user of the client device 102 informs the DBA 400 that the external promotion has not occurred, and requests that the DBA 400 perform the promotion. The DBA 400 then sends instructions 432 to perform the external promotion, which results in Table X 404 being promoted to the external database 408 of the target system 106. The user of the client device 102 can then send instructions 440 to re-promote the version tag with Entity Y V1.0, which now results in a successful promotion, as shown in FIG. 4C. Thus, the metadata tagging and promotion techniques described herein can also guide users to correct issues external to the promotion, thereby improving the quality of promoted metadata and/or data and reducing errors in promotion overall.

Referring to FIG. 5A, a view 500 depicting an example of metadata promotion is shown. This example is substantially similar to the example described with reference to FIG. 3E, but rather than directly transmitting the version tag, entities, and artifacts from the source system 104 to the target system 106 (e.g., consolidated promotion), an archive file 502 is created from the version tag, entities, and artifacts and stored in hardware storage 504. Then, the archive file 502 can be manually loaded from the hardware storage 504 into the target system 106 to complete the promotion, as shown in view 510 of FIG. 5B. This method can increase the security of the promotion and is useful when the source system 104 and target system 106 cannot communicate, for example, because a firewall separates the source and target systems and their respective metadata and technical repositories.

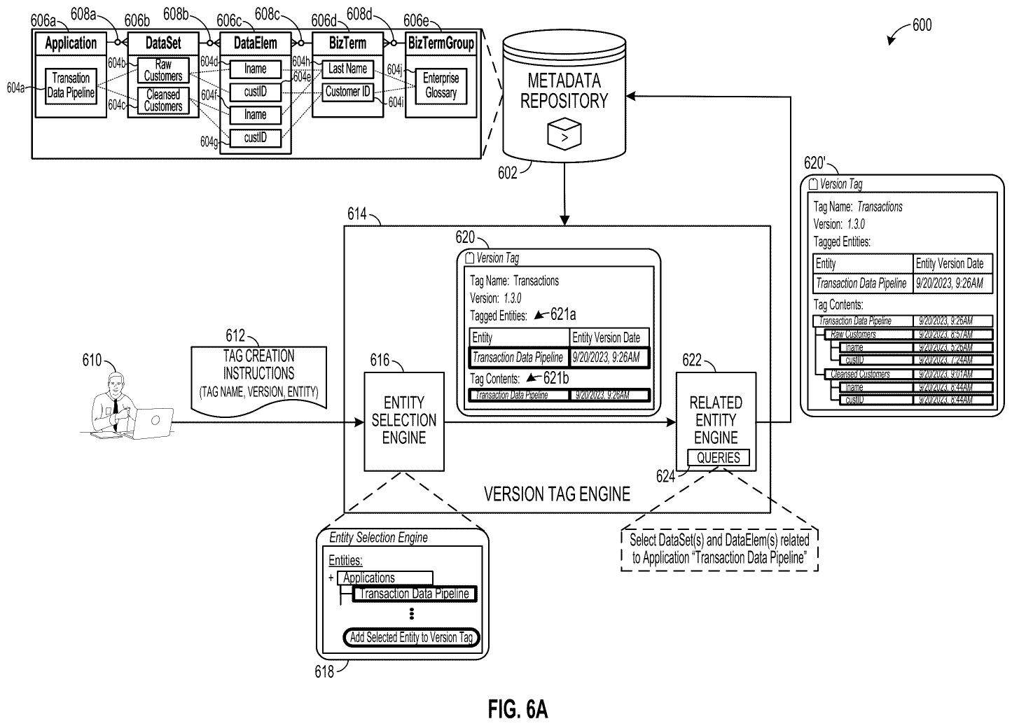

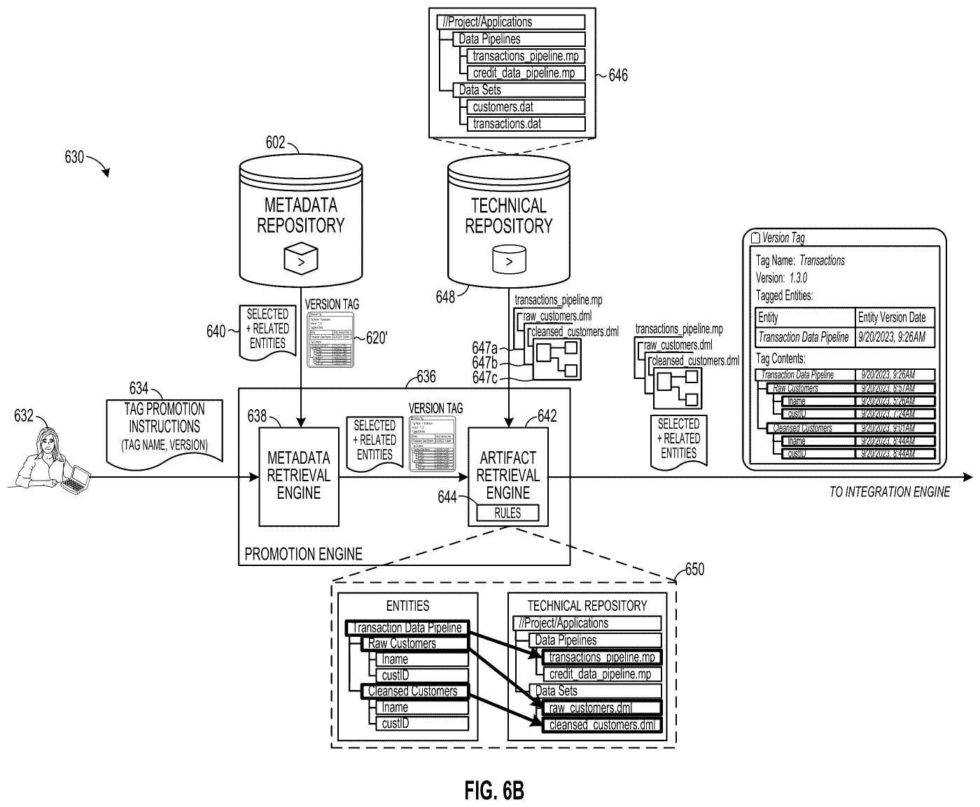

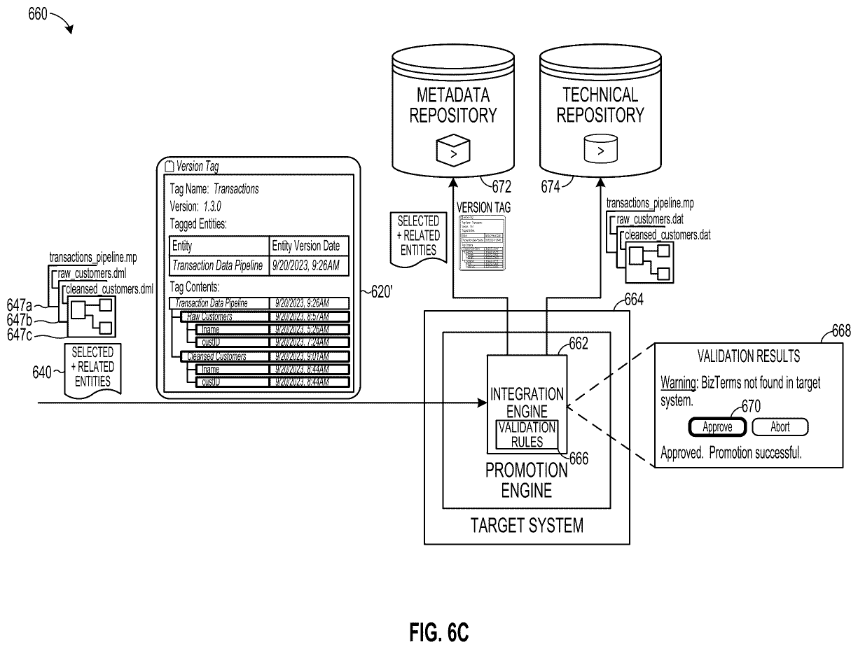

Referring to FIG. 6A, a view 600 depicting an example of metadata tagging is shown. In this example, a metadata repository 602 of a source system stores entities 604a-604j that each belong to a respective entity class 606a-606e, and include metadata specifying attributes of an item of physical or logical data in the entity class. Each entity 604a-604j can also include a version. A schema or model can define relationships 608a-608d among the entity classes 606a-606e, which in turn can be used to specify relationships among the entities 604a-604j.

In this example, a user 610 provides (e.g., via a client device) tag creation instructions 612 to an entity selection engine 616 of a version tag engine 614 in a source system. The tag creation instructions 612 can include, for example, a tag name, a tag version, and a specification of one or more entities for inclusion in the tag. In this example, the user 610 has specified in the instructions 612 a tag name of “Transactions” and a tag version of 1.3.0, and has further specified a “Transaction Data Pipeline” entity for inclusion in the tag, as shown in visualization 618. Responsive to the instructions 612, the entity selection engine 616 creates a version tag 620, and transmits the version tag 620 to a related entity engine 622. In this example, the version tag includes a tagged entity portion 621a that indicates the entities and versions of the entities specified by the user, as well as a tag contents portion 621b that indicates all of the entities and versions of the entities included in the version tag 620. In this example, the versions are particular dates of the entities.

The related entity engine 622 executes one or more related content queries 624 to identify specific versions of entities related to the entities specified by the user 610. In this example, the related entity engine 622 invokes a related content query 624 that selects all dataset entities and data element entities related to the “Transaction Data Pipeline” application entity. Based on this query, the related entity engine 622 identifies as related entities the “Raw Customers” dataset entity and its “Iname” and “custID” data element entities, as well as the “Cleansed Customers” dataset entity and its “Iname” and “custID” data element entities. As such, the related entity engine 622 updates the version tag to include these related entities and their respective versions, and stores the updated version tag 620′ in the metadata repository 602.

Referring to FIG. 6B, a view 630 depicting an example of metadata promotion is shown. In this example, a user 632 transmits tag promotion instructions 634 to a metadata retrieval engine 638 of a promotion engine 636 in the source system. The tag promotion instructions 634 can include, for example, the tag name (e.g., “Transactions”) and the tag version (e.g., 1.3.0). Responsive to the instructions 634, the metadata retrieval engine 638 retrieves the version tag 620′ and its associated entities 640 from the metadata repository 602, and transmits this data to the artifact retrieval engine 642.

The artifact retrieval engine 642 evaluates the entities 640 in accordance with one or more pre-defined rules 644 to determine whether any artifacts 646 in a technical repository 648 of the source system should be promoted along with the entities 640. In this example, the artifact retrieval engine 642 determines that artifact “transactions_pipeline.mp” should be promoted along with entity “Transaction Data Pipeline,” artifact “raw_customers.dml” should be promoted along with entity “Raw Customers,” and artifact “cleansed_customers.dml” should be promoted along with entity “Cleansed Customers,” as shown in the visualization 650. As such, the artifact retrieval engine 642 retrieves artifacts 647a-647c, and then promotes the version tag 620′, the entities 640, and the artifacts 647a-647c to the integration engine of the target system.

Referring to FIG. 6C, a view 660 depicting an example of metadata promotion is shown. In this example, an integration engine 662 of the target system 664 receives the version tag 620′, the entities 640, and the artifacts 647a-647c from the source system. The integration engine 662 then applies one or more validation rules 666 to validate the entities 640 and the artifacts 647a-647c prior to integration into the target system 664.

In this example, the integration engine 662 determines that the promoted metadata entities do not satisfy the criteria of the validation rules 666. Specifically, the integration determines 662 determines that the business terms for promoted entities 640 are not found within the target system 664, as shown in validation results 668. Since the failed validation is an optional structural validation, the integration engine 662 warns the user and gives the user an option to approve the validation failure and proceed with the promotion, or abort the promotion. In this example, the user opts to proceed with the promotion by selecting the approve option 670. As such, the integration engine 662 loads (e.g., inserts, updates, or deletes) the version tag and the entities 640 into a metadata repository 672 of the target system 664, and loads the artifacts 647a-647c into a technical repository 674 of the target system 664. Once promotion is complete, the promoted version tag, entities, and artifacts can be used (e.g., by applications) within the target system as they were in the source system.

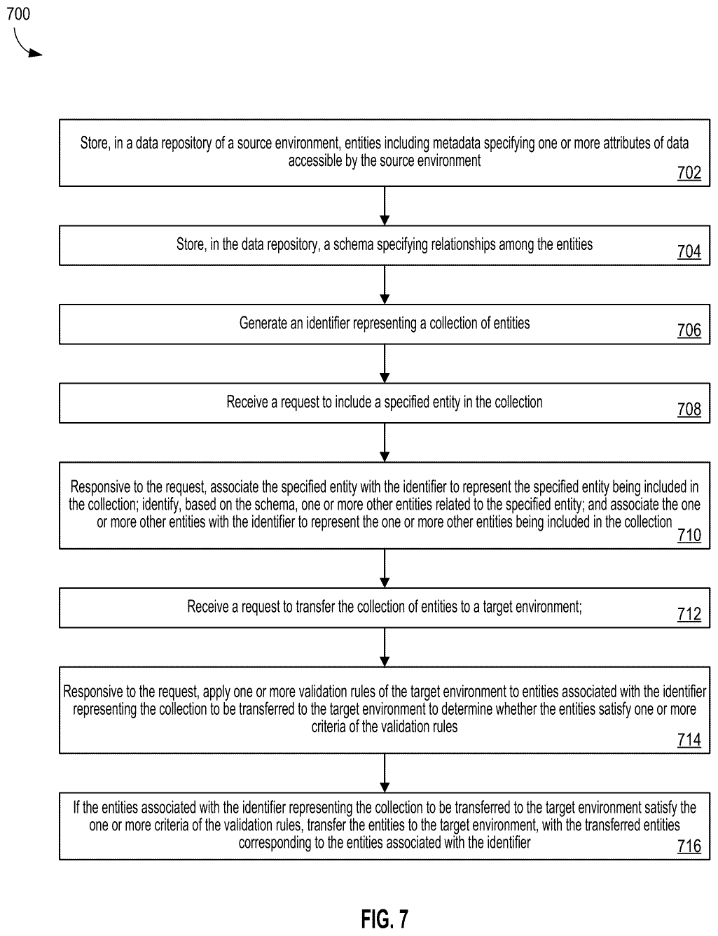

Referring to FIG. 7, an example process 700 for metadata tagging and promotion is shown. In some examples, the process 700 is performed by a data processing system, such as the source system 104 and/or the target system 106.

Operations of the process 700 include storing, in a data repository of a source environment, entities including metadata specifying one or more attributes of data accessible by the source environment (702). A schema specifying relationships among the entities is also stored in the data repository (704). An identifier representing a collection of entities (e.g., a version tag) is generated (706). A request to include a specified entity in the collection is received, for example, from a client device (708).

In response to the request, the specified entity is associated with the identifier to represent the specified entity being included in the collection (710). For example, the specified entity or a reference to the specified entity can be added to the identifier (e.g., version tag). Based on the schema, one or more other entities related to the specified entity are identified. In some examples, the one or more other entities are identified via a related content query selected based on the specified entity. The identified one or more other entities are associated with the identifier to represent the one or more other entities being included in the collection.

Operations of the process 700 further include receiving a request to transfer the collection of entities to a target environment (712). Responsive to the request, one or more validation rules of the target environment are applied to entities associated with the identifier representing the collection to be transferred to the target environment to determine whether the entities satisfy one or more criteria of the validation rules (714). If the entities associated with the identifier representing the collection to be transferred to the target environment satisfy the one or more criteria of the validation rules, the entities are transferred to the target environment, with the transferred entities corresponding to the entities associated with the identifier (716).

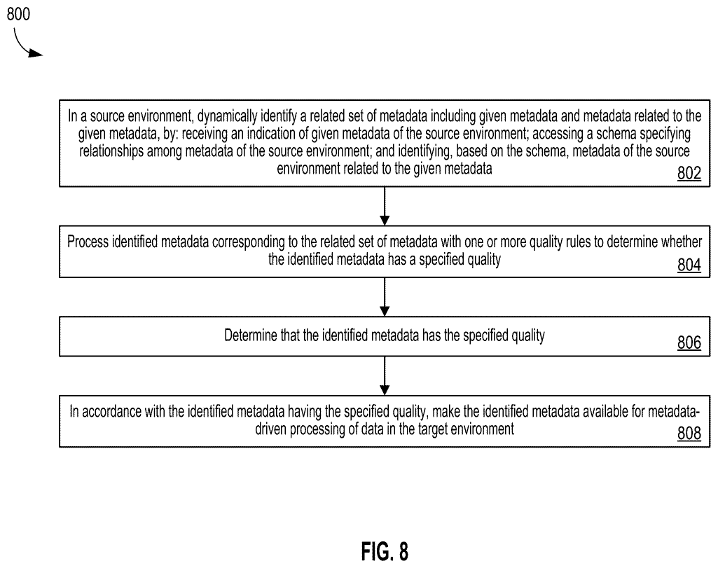

Referring to FIG. 8, an example process 800 for metadata tagging and promotion is shown. In some examples, the process 800 is performed by a data processing system, such as the source system 104 and/or the target system 106.

Operations of the process 800 include in a source environment, dynamically identifying, by a data processing system, a related set of metadata including given metadata and metadata related to the given metadata, by: receiving an indication of given metadata of the source environment; accessing a schema specifying relationships among metadata of the source environment; and identifying, based on the schema, metadata of the source environment related to the given metadata (802).

The identified metadata corresponding to the related set of metadata is processed with one or more quality rules to determine whether the identified metadata has a specified quality (804). It is determined by the data processing system that the identified metadata has the specified quality (806). In accordance with the identified metadata having the specified quality, the data processing system makes the identified metadata available for metadata-driven processing of data in the target environment. For example, the data processing system can store the identified metadata in a repository of the target environment or otherwise modify the repository such that the identified metadata is available for metadata-driven processing of data in the target environment. In some examples, making the identified metadata available in the target environment includes making the identified metadata accessible to one or more applications of the target environment, and/or incorporating the identified metadata into a data catalog of the target environment.

A computation can be expressed as data flow through a computational graph with nodes and links. The computation includes components specifying portions of the computation. A node represents one or more of these components. The nodes are connected by the links to represent data flow, such as flow of data records, among the components. As such, a computational graph may also be referred to as a dataflow graph. The dataflow graph itself is executable, e.g., by compiling or otherwise processing the dataflow graph to generate executable computer code.

As described herein, dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input, (e.g., a data source) and providing data to at least one data output, (e.g., a data sink) of a system. The dataflow graph can thus implement a graph-based computation performed on data flowing from one or more input datasets through the graph components to one or more output datasets.

A component may be an upstream component, a downstream component, or both. An upstream component includes a component that outputs data to another component. downstream component includes a component that receives data from another component. Additionally, components include input and output ports. The links are directed links that are coupled from an output port of an upstream component to an input port of a downstream component. The ports have indicators that represent characteristics of how data is written to and read from the links and/or how the components are controlled to process data.

These ports may have various characteristics. For example, one characteristic of a port is its directionality as an input port or output port. The directed links represent data and/or control being conveyed from an output port of an upstream component to an input port of a downstream component.

A subset of the components serves as sources and/or sinks of data from the overall computation, for example, to and/or from data files, database tables, and external data flows. Parallelism can be achieved at least by enabling different components to be executed in parallel by different processes (hosted on the same or different server computers or processor cores), where different components executing in parallel on different paths through a dataflow graph is referred to as component parallelism, and different components executing in parallel on different portions of the same path through a dataflow graph is referred to as pipeline parallelism.

A system also includes a data processing system for executing one or more computer programs (such as dataflow graphs), which were generated by the transformation of a specification into the computer program(s) using a transform generator and techniques described herein. The transform generator transforms the specification into the computer program. In this example, the selections made by user through the user interfaces described here form a specification that specify which data sources to ingest. Based on the specification, the transforms described herein are generated.

The data processing system may be hosted on one or more general-purpose computers under the control of a suitable operating system, such as the UNIX operating system. For example, the data processing system can include a multiple-node parallel computing environment including a configuration of computer systems using multiple central processing units (CPUs), either local (e.g., multiprocessor systems such as SMP computers), or locally distributed (e.g., multiple processors coupled as clusters or MPPs), or remotely distributed (e.g., multiple processors coupled via LAN or WAN networks), or any combination thereof.

The graph configuration approach described above can be implemented using software for execution on a computer. For instance, the software forms procedures in one or more computer programs that execute on one or more systems, e.g., computer programmed or computer programmable systems (which may be of various architectures such as distributed, client/server, or grid) each including at least one processor, at least one data storage system (including volatile and non-volatile memory and/or storage elements), at least one input device or port, and at least one output device or port. The software may form one or more modules of a larger computer program, for example, that provides other services related to the design and configuration of dataflow graphs. The nodes and elements of the graph can be implemented as data structures stored in a computer readable medium or other organized data conforming to a data model stored in a data repository.

The software may be provided on a non-transitory storage medium, such as a hardware storage device, e.g., a CD-ROM, readable by a general or special purpose programmable computer or delivered (encoded in a propagated signal) over a communication medium of a network to the computer where it is executed. All of the functions may be performed on a special purpose computer, or using special-purpose hardware, such as coprocessors. The software may be implemented in a distributed manner in which different parts of the dataflow specified by the software are performed by different computers. Each such computer program is preferably stored on or downloaded to a non-transitory storage media or hardware storage device (e.g., solid state memory or media, or magnetic or optical media) readable by a general or special purpose programmable computer, for configuring and operating the computer when the non-transitory storage media or device is read by the system to perform the procedures described herein. The system may also be considered to be implemented as a computer-readable storage medium, configured with a computer program, where the storage medium so configured causes the system to operate in a specific and predefined manner to perform the functions described herein.

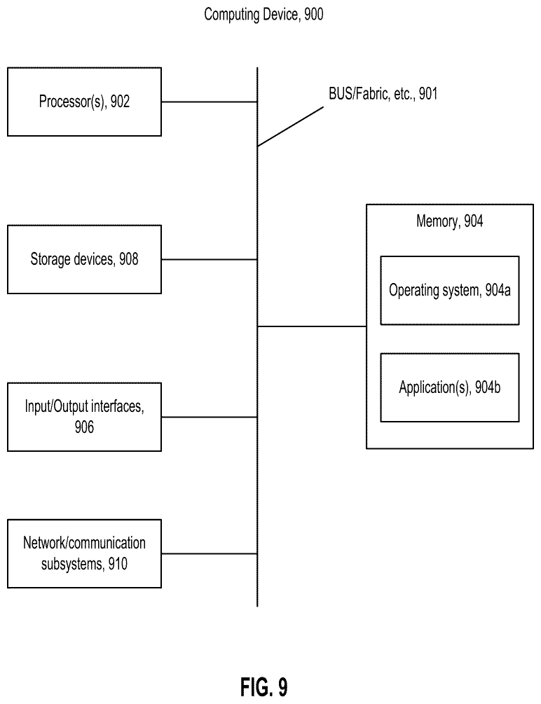

Referring to FIG. 9, an example operating environment for implementing embodiments of the present invention is shown and designated generally as computing device 900. Essential elements of a computing device 900 or a computer or data processing system or client or server are one or more programmable processors 902 for performing actions in accordance with instructions and one or more memory devices 904 for storing instructions and data. Generally, a computer will also include, or be operatively coupled, (via bus 901, fabric, network, etc.) to I/O components 906, e.g., display devices, network/communication subsystems, etc. (not shown) and one or more mass storage devices 908 for storing data and instructions, etc., and a network communication subsystem 910, which are powered by a power supply (not shown). In memory 194, are an operating system 904a and applications 904b for application programming.

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user's device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A method performed by a data processing system for delivering a dynamically identified set of related metadata of a specified quality to a target environment for metadata-driven processing of data, comprising:
in a source environment, dynamically identifying, by the data processing system, a related set of metadata including given metadata and metadata related to the given metadata, by:
receiving an indication of given metadata of the source environment;
accessing a schema specifying relationships among metadata of the source environment; and
identifying, based on the schema, metadata of the source environment related to the given metadata;
processing, by the data processing system, identified metadata corresponding to the related set of metadata with one or more quality rules to determine whether the identified metadata has a specified quality;
determining, by the data processing system, that the identified metadata has the specified quality; and
in accordance with the identified metadata having the specified quality, making the identified metadata available for metadata-driven processing of data in the target environment.

2. The method of claim 1, further comprising:
identifying one or more items of data associated with the related set of metadata; and
retrieving, from a data repository, the one or more items of data.

3. The method of claim 2, wherein the one or more quality rules comprise first quality rules, the method further comprising:
processing, by the data processing system, the one or more items of data with one or more second quality rules to determine whether the one or more items of data have a specified quality;
determining, by the data processing system, that the one or more items of data have the specified quality; and
in accordance with the one or more items of data having the specified quality, making the one or more items of data available in the target environment.

4. The method of claim 2, wherein the one or more items of data comprise at least one of: a record format definition associated the related set of metadata, application logic associated with the related set of metadata, or properties of the related set of metadata.

5. The method of claim 1, further comprising receiving an indication of a version for the given metadata.

6. The method of claim 5, wherein identifying the related set of metadata includes identifying, based on the schema, metadata related to the version of the given metadata.

7. The method of claim 1, further comprising receiving an indication of a version for the related set of metadata.

8. The method of claim 1, wherein making the identified metadata available in the target environment comprises modifying a repository of the target environment such that the identified metadata is available for metadata-driven processing of data in the target environment.

9. The method of claim 1, wherein making the identified metadata available in the target environment comprises storing the identified metadata in a repository of the target environment.

10. The method of claim 1, wherein making the identified metadata available in the target environment comprises making the identified metadata accessible to one or more applications of the target environment, or incorporating the identified metadata into a data catalog of the target environment.

11. The method of claim 1, wherein making the identified metadata available in the target environment comprises at least one of: transferring the identified metadata to the target environment, inserting the identified metadata into a repository of the target environment, updating one or more values of metadata in the repository of the target environment based on the identified metadata, deleting metadata from the repository of the target environment based on the identified metadata, or changing logical ownership of the identified metadata within the target environment.

12. The method of claim 1, further comprising:
determining that at least a portion of the identified metadata does not have the specified quality; and
causing display of information regarding a cause of the at least the portion of the identified metadata not having the specified quality.

13. The method of claim 12, further comprising:
responsive to the display of the information regarding the cause of the at least the portion of the identified metadata not having the specified quality, receiving a request to include additional metadata in the related set of metadata; and
associating the additional metadata with the related set of metadata.

14. The method of claim 12, further comprising:
responsive to the display of the information regarding the cause of the at least the portion of the identified metadata not having the specified quality, receiving an indication to override; and
responsive to the indication to override, making the identified metadata available in the target environment.

15. The method of claim 1, further comprising:
determining that at least a portion of the identified metadata does not have the specified quality; and
in accordance with the at least the portion of the identified metadata not having the specified quality, aborting making the identified metadata available in the target environment.

16. The method of claim 1, wherein the one or more quality rules comprise at least one of a structural quality rule or a semantic quality rule, wherein the structural quality rule comprises criterion for one or more references of the identified metadata within the target environment to specify a required referential integrity, and wherein the semantic quality rule comprises criterion for attributes of the identified metadata.

17. The method of claim 1, further comprising:
accessing, from a repository of the target environment, an application; and
executing the application in accordance with the identified metadata.

18. The method of claim 1, wherein identifying the metadata related to the given metadata comprises querying a repository of the source environment in accordance with a related content query, wherein the related content query is configured to select the metadata related to the given metadata.

19. The method of claim 1, wherein the related set of metadata includes references to the given metadata and the metadata related to the given metadata.

20. The method of claim 1, wherein making the identified metadata available in the target environment comprises:
generating an archive file comprising the identified metadata; and
transferring the archive file to the target environment.

21. The method of claim 1, wherein processing the identified metadata with the one or more quality rules comprises:
determining that the identified metadata would likely cause an error within the target environment by determining that at least one of:
a) metadata within the target environment,
b) a reference to metadata within the target environment, or
c) a piece of application logic,
is not found that is needed for a successful integration into the target environment of the identified metadata.

22. The method of claim 1, wherein the source environment is a development environment for an application and the target environment is a test environment or a production environment for the application.

23. The method of claim 1, wherein making the identified metadata available in the target environment comprises:
storing the identified metadata in a first state in a repository of the target environment, wherein the identified metadata is unavailable in the target environment when in the first state;
receiving an indication to transition the identified metadata from the first state to a second state, wherein the metadata is available in the target environment when in the second state; and
in response to the indication, transitioning the metadata to the second state.

24. The method of claim 1, further comprising:
identifying a version conflict among the metadata related to the given metadata; and
causing display of information regarding the version conflict.

25. The method of claim 24, further comprising:
in response to the display of the information regarding the version conflict, receiving selection data specifying selection of a particular version for the metadata related to the given metadata; and
including the particular version of the metadata related to the given metadata in the related set of metadata.

26. The method of claim 1,
receiving data input into a user interface, the data specifying the source environment, the target environment, and instructions to transfer the related set of metadata from the source environment to the target environment.

27. A system for delivering a dynamically identified set of related metadata of a specified quality to a target environment for metadata-driven processing of data, comprising:
one or more processors; and
memory storing instructions executable by the one or more processors to perform operations comprising:
in a source environment, dynamically identifying a related set of metadata including given metadata and metadata related to the given metadata, by:
receiving an indication of given metadata of the source environment;
accessing a schema specifying relationships among metadata of the source environment; and
identifying, based on the schema, metadata of the source environment related to the given metadata;
processing identified metadata corresponding to the related set of metadata with one or more quality rules to determine whether the identified metadata has a specified quality;
determining that the identified metadata has the specified quality; and
in accordance with the identified metadata having the specified quality, making the identified metadata available for metadata-driven processing of data in the target environment.

28. A computer-readable storage medium storing instructions executable by one or more processors to cause the one or more processors to perform operations comprising:
in a source environment, dynamically identifying a related set of metadata including given metadata and metadata related to the given metadata, by:
receiving an indication of given metadata of the source environment;
accessing a schema specifying relationships among metadata of the source environment; and
identifying, based on the schema, metadata of the source environment related to the given metadata;
processing identified metadata corresponding to the related set of metadata with one or more quality rules to determine whether the identified metadata has a specified quality;
determining that the identified metadata has the specified quality; and
in accordance with the identified metadata having the specified quality, making the identified metadata available for metadata-driven processing of data in a target environment.
